(19) United States
(12) Patent Application Publication
(10) Pub. No.: US 2026/0259612 A1
(43) Pub. Date: Sep. 3, 2026

(54) SCENE DESCRIPTION FRAMEWORK FOR HAPTICS INTERACTIVITY

(71) Applicant: InterDigital CE Patent Holdings, SAS, Paris (FR)

(72) Inventors: Quentin GALVANE, THORIGNE-FOUILLARD (FR); Philippe GUILLOTEL, VERN SUR SEICHE (FR); Pierrick JOUET, RENNES (FR); Patrice HIRTZLIN, BETTON (FR); Gurvan LECUYER, RENNES (FR)

(21) Appl. No.: 19/164,751

(22) PCT Filed: Mar. 11, 2024
(86) PCT No.: PCT/EP2024/056437

§ 371 Date: Sep. 12, 2025

(30) Foreign Application Priority Data
Mar. 16, 2023 (EP) 23305357.8
Mar. 31, 2023 (EP) 23305464.2

(51) Int. Cl. G06F 3/01

(52) U.S. Cl. CPC G06F 3/016

(57) ABSTRACT

An immersive scene description is defined by a data structure comprising information representative of a trigger and a haptic effect. When the trigger occurs while a user interacts with the immersive scene, parameters of the haptic effect are obtained from the data structure and are provided to haptic actuators for rendering of the haptic effect. These parameters determine at least the modality and perception of the haptic effect and may determine at least one part of the body on which the haptic effect should be applied. The modality is related to the type of haptic effect, such as temperature, vibrotactile, pressure, acceleration, etc. The perception determines the haptic signal to be applied to the corresponding haptic actuator. This signal may be generated or obtained from a file or from another device.

### CROSS-REFERENCE TO RELATED APPLICATIONS

This application claims the priority to European Application No 23305357.8 filed 16 Mar. 2023 and European Application No 23305464.2 filed 31 Mar. 2023, which are incorporated herein by reference in their entirety.

### TECHNICAL FIELD

At least one of the present embodiments generally relates to immersive scene description and more particularly to a format and syntax for interactive haptic effects.

### BACKGROUND

In recent years, the field of virtual reality has rapidly advanced, allowing users to immerse themselves in a virtual world and interact with objects within it. Fully immersive user experiences are proposed to users through immersive systems based on feedback and interactions. The interaction may use conventional ways of control that fulfill the need of the users. Current visual and auditory feedback provide satisfying levels of realistic immersion. Additional feedback can be provided by haptic effects that allow a human user to perceive a virtual environment with his senses and thus get a better experience of the full immersion with improved realism. However, haptics is still one area of potential progress to improve the overall user experience in an immersive system.

Conventionally, an immersive system may comprise a 3D scene representing a virtual environment with virtual objects localized within the 3D scene. To improve the user interaction with the elements of the virtual environment, haptic feedback may be used through stimulation of haptic actuators. Such interaction is based on the notion of “haptic objects” that correspond to physical phenomena to be transmitted to the user. In the context of an immersive scene, a haptic object allows to provide a haptic effect by defining the stimulation of appropriate haptic actuators to mimic the physical phenomenon on the haptic rendering device. Different types of haptic actuators allow to restitute different types of haptic feedbacks.

An example of a haptic object is an explosion. An explosion can be rendered though vibrations and heat, thus combining different haptic effects on the user to improve the realism. An immersive scene typically comprises multiple haptic objects, for example using a first haptic object related to a global effect and a second haptic object related to a local effect.

The principles described herein apply to any immersive environment using haptics such as augmented reality, virtual reality, mixed reality or haptics-enhanced video (or omnidirectional/360° video) rendering, for example, and more generally apply to any haptics-based user experience. A scene for such examples of immersive environments is thus considered an immersive scene.

Haptics refers to sense of touch and includes two dimensions, tactile and kinesthetic. The first one relates to tactile sensations such as friction, roughness, hardness, temperature and is felt through the mechanoreceptors of the skin (Merkel cell, Ruffini ending, Meissner corpuscle, Pacinian corpuscle) and thermoreceptors. The second one is linked to the sensation of force/torque, position, motion/velocity provided by the muscles, tendons and the mechanoreceptors in the joints. Haptics is also involved in the perception of self-motion since it contributes to the proprioceptive system (i.e., perception of one's own body). Thus, the perception of acceleration, speed or any body model could be assimilated as a haptic effect. The frequency range is about 0-1 kHz depending on the type of modality. Most existing devices able to render haptic signals generate vibrations. Examples of such haptic actuators are linear resonant actuator (LRA), eccentric rotating mass (ERM), and voice-coil linear motor. These actuators may be integrated into haptic rendering devices such as haptic suits but also smartphones or game controllers.

In order to convey the immersive scene information, it is important to use a syntax format that accurately describes the virtual environment and the objects within it. This syntax format may be designed to be easily interpreted by both human users that conceive an immersive scene and computer systems that interpret and render the immersive scene.

To encode haptic signals, several formats have been defined related to either a high-level description using XML-like formats (for example MPEG-V), parametric representation using json-like formats such as Apple Haptic Audio Pattern (AHAP) or Immersion Corporation's HAPT format, or waveform encoding (IEEE 1918.1.1 ongoing standardization for tactile and kinesthetic signals). The HAPT format has been recently included into the MPEG ISOBMFF file format specification (ISO/IEC 14496 part 12). Moreover, GL Transmission Format (glTF™) is a royalty-free specification for the efficient transmission and loading of 3D scenes and models by applications. This format defines an extensible, common publishing format for 3D content tools and services that streamlines authoring workflows and enables interoperable use of content across the industry.

Moreover, a haptic file format is being defined within the MPEG standardization group and relates to a coded representation for haptics. With this format, the encoded haptic description file can be exported either as a JSON interchange format (for example a .hjif file) that is human readable or as a compressed binary distribution format (for example a .mpg) that is particularly adapted for transmission towards haptic rendering devices. Additionally, in MPEG a standard focusing on Scene Description was released. This MPEG-I Scene Description (SD) standard is an extension to the existing glTF™ format. Amendments to this MPEG-I SD standard are being defined and focus on several aspects, including Interactivity and Haptics. Embodiments described herein build upon the MPEG-I SD standard.

### SUMMARY

Embodiments described hereafter have been designed with the foregoing in mind and introduce the notion of an interactive haptic action defined within an immersive scene description as a data structure comprising information representative of a trigger and a haptic effect. When the trigger occurs while a user interacts with the immersive scene, parameters of the haptic effect are obtained from the data structure and are provided to haptic actuators for rendering of the haptic effect. These parameters determine at least the modality and perception of the haptic effect and may determine at least one part of the body on which the haptic effect should be applied. The modality is related to the type of haptic effect (such as temperature, vibrotactile, pressure, acceleration, etc.). The perception determines the haptic signal to be applied to the corresponding haptic actuator. This signal may be generated or obtained from a file or from another device.

A first aspect of at least one embodiment is directed to a method comprising obtaining, from an immersive scene description, data structure representative of an interactive haptic action, the data structure being associated with a virtual object or immersive scene and defining a behavior based on a trigger and an action, the action being associated with a haptic effect, responsive to an occurrence of an event corresponding to the trigger, determining parameters of the haptic effect, the parameter comprising at least a type of haptic effect and a perception of haptic signal for the haptic effect, and providing haptic data for rendering the haptic effect based at least on the type of haptic effect and a perception of haptic signal for the haptic effect.

A second aspect of at least one embodiment is directed to a device for comprising a processor configured to obtain, from an immersive scene description, data structure representative of an interactive haptic action, the data structure being associated with a virtual object or immersive scene and defining a behavior based on a trigger and an action, the action being associated with a haptic effect, responsive to an occurrence of an event corresponding to the trigger, determine parameters of the haptic effect, the parameter comprising at least a type of haptic effect and a perception of haptic signal for the haptic effect, and provide haptic data for rendering the haptic effect based at least on the type of haptic effect and a perception of haptic signal for the haptic effect.

A third aspect of at least one embodiment is directed to a computer program comprising program code instructions executable by a processor for implementing at least the steps of a method according to the first aspect.

A fourth aspect of at least one embodiment is directed to a non-transitory computer readable medium storing program code instructions executable by a processor for implementing at least the steps of a method according to the first aspect.

### BRIEF DESCRIPTION OF THE DRAWINGS

FIG. 1 illustrates a block diagram of an example of immersive system in which various aspects and embodiments are implemented.

FIG. 2 illustrates an example of data structure of an immersive scene description according to at least one embodiment.

FIG. 3 illustrates an example of data structure for a haptic object.

FIG. 4 illustrates an example of instantiation of a data structure for a haptic object.

FIG. 5 illustrates a simple example of data structure for an interactive haptic action.

FIG. 6 illustrates an example of data structure for an interactive haptic action according to a first embodiment.

FIG. 7 illustrates an example of data structure for an interactive haptic action according to a second embodiment.

FIG. 8 illustrates an example of data structure for an interactive haptic action according to a third embodiment.

FIG. 9 illustrates an example of data structure for an interactive haptic action according to a fourth embodiment.

FIG. 10 shows an example of architecture of a scene description comprising an interactive haptic action according to the first embodiment.

FIG. 11 shows an example of architecture of a scene description comprising an interactive haptic action according to the second embodiment.

FIG. 12 shows an example of architecture of a scene description comprising an interactive haptic action according to the third embodiment.

FIG. 13 shows an example of flowchart for handling interactive haptic actions according to at least one embodiment.

### DETAILED DESCRIPTION

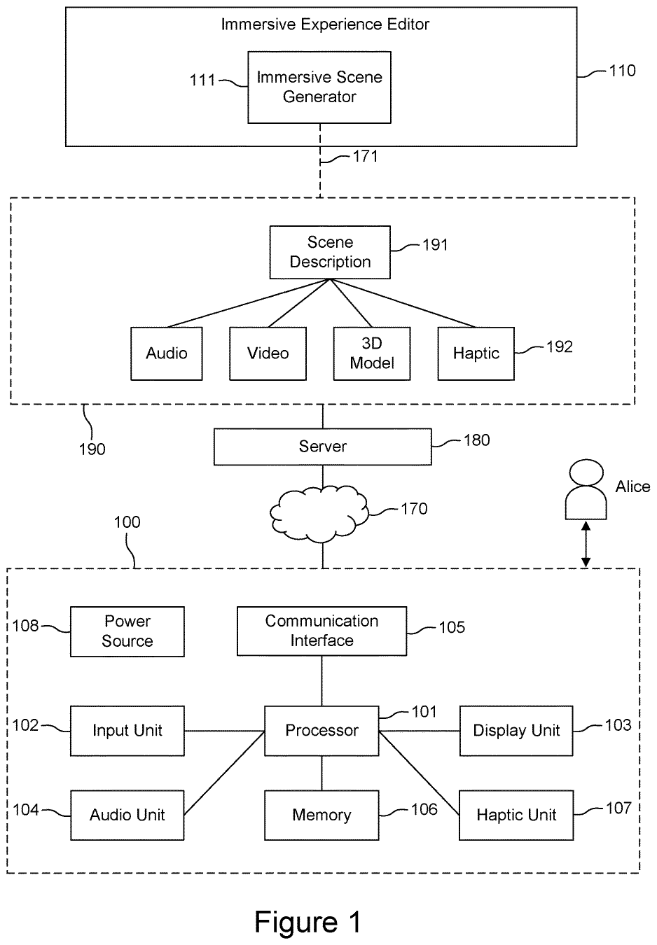

FIG. 1 illustrates a block diagram of an example of immersive system in which various aspects and embodiments are implemented. In the depicted immersive system, the user Alice uses the haptic rendering device 100 to interact with a server 180 hosting an immersive scene 190 through a communication network 170. This immersive scene 190 may comprise various data and/or files representing different elements (scene description 191, audio data, video data, 3D models, and haptic description file 192) required for its rendering. The immersive scene 190 may be generated under control of an immersive experience editor 110 that allows to arrange the different elements together and design an immersive experience. Appropriate description files and various data files representing the immersive experience are generated by an immersive scene generator 111 (a.k.a. encoder), encoded in a format adapted for transmission to haptic rendering devices and stored on the server 180. The immersive experience editor 110 is typically hosted by a computer and may comprise a graphical user interface configured to generate the immersive scene. For the sake of simplicity, the immersive experience editor 110 is illustrated as being directly connected through the dotted line 171 to the immersive scene 190. In practice, the immersive scene 190 is hosted on the server 180 and the computer running the immersive experience editor 110 is connected to the server 180 through the communication network 170.

The haptic rendering device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as haptic signal decoding, input/output processing, and/or any other functionality that enables the device to operate in an immersive system.

The processor 101 may be coupled to an input unit 102 configured to convey user interactions. Multiple types of inputs and modalities can be used for that purpose. A physical keypad and a touch sensitive surface are typical examples of input units adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation. The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example. The processor 101 may be coupled to a communication interface 105 configured to exchange data with external devices. The communication preferably uses a wireless communication standard to provide mobility of the haptic rendering device, such as cellular (e.g. LTE) communications, Wi-Fi communications, and the like. The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 is coupled to a haptic unit 107 configured to provide haptic feedback to the user, the haptic feedback being described in the haptic description file 192 that is related to the scene description 191 of the immersive scene 190. The haptic description file 192 describes the kind of feedback to be provided according to the syntax described further hereinafter. Such description file is typically conveyed from the server 180 to the haptic rendering device 100. The haptic unit 107 may comprise a single haptic actuator or a plurality of haptic actuators located at a plurality of positions on the haptic rendering device. Different haptic units may have a different number of actuators and/or the actuators may be positioned differently on the haptic rendering device.

In at least one embodiment, the processor 101 is configured to render a haptic signal according to embodiments described further below, in other words to apply a low-level signal to a haptic actuator to render the haptic effect. Such low-level signal may be represented using different forms, for example by metadata or parameters in the description file or by using a digital encoding of a sampled analog signal (e.g., PCM or LPCM).

The processor 101 may receive power from the power source 108 and may be configured to distribute and/or control the power to the other components in the device 100. The power source 108 may be any suitable device for powering the device. As examples, the power source 108 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated in an electronic package or chip. It will be appreciated that the haptic rendering device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include sensors such as a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the haptic rendering device within its environment. The localization unit may integrate a GPS chipset providing longitude and latitude position regarding the current location of the haptic rendering device but also motion sensors such as an accelerometer and/or an e-compass that provide localization services.

Typical examples of a haptic rendering device 100 are haptic suits, smartphones, game controllers, haptic gloves, haptic chairs, haptic props, motion platforms, etc. However, any device or composition of devices that provides similar functionalities can be used as haptic rendering device 100 while still conforming with the principles of the disclosure.

In at least one embodiment, the device does not include a display unit but includes a haptic unit. In such embodiment, the device does not render the scene visually but only renders haptic effects. However, the device may prepare data for display so that another device, such as a screen, can perform the display. Example of such devices are haptic suits or motion platforms.

In at least one embodiment, the device does not include a haptic unit but includes a display unit. In such embodiment, the device does not render the haptic effect but only renders the scene visually. However, the device may prepare data for rendering the haptic effect so that another device, such as a haptic prop, can perform the haptic rendering. Examples of such devices are smartphones, head-mounted displays, or laptops.

In at least one embodiment, the device does not include a display unit, nor does it include a haptic unit. In such embodiment, the device does not visually render the scene and does not render the haptic effects. However, the device may prepare data for display so that another device, such as a screen, can perform the display and may prepare data for rendering the haptic effect so that another device, such as a haptic prop, can perform the haptic rendering. Examples of such devices are computers, game consoles, optical media players, or set-top boxes.

In at least one embodiment, the immersive scene 190 and associated elements are directly hosted in memory 106 of the haptic rendering device 100 allowing local rendering and interactions. In a variant of this embodiment, the device 100 also comprises the immersive experience editor 110 allowing a fully standalone operation, for example without needing any communication network 170 and server 180.

Although the different elements of the immersive scene 190 are depicted in FIG. 1 as separate elements, the principles described herein apply also in the case where these elements are directly integrated in the scene description and not separate elements. Any mix between two alternatives is also possible, with some of the elements integrated in the scene description and other elements being separate files.

Although the haptic rendering device 100 is described herein as a single device, it may also be implemented as a combination of separate haptic rendering devices.

For the sake of simplicity of the description, interactions and haptic effects are described herein using a finger touching a tactile surface as interaction medium. However, any other element representing the position of the user in the immersive environment (such as a body part of the user, the position provided by a force-feedback device, the localization of a head-mounted display in a virtual reality environment) may be used, still relying on the same principles.

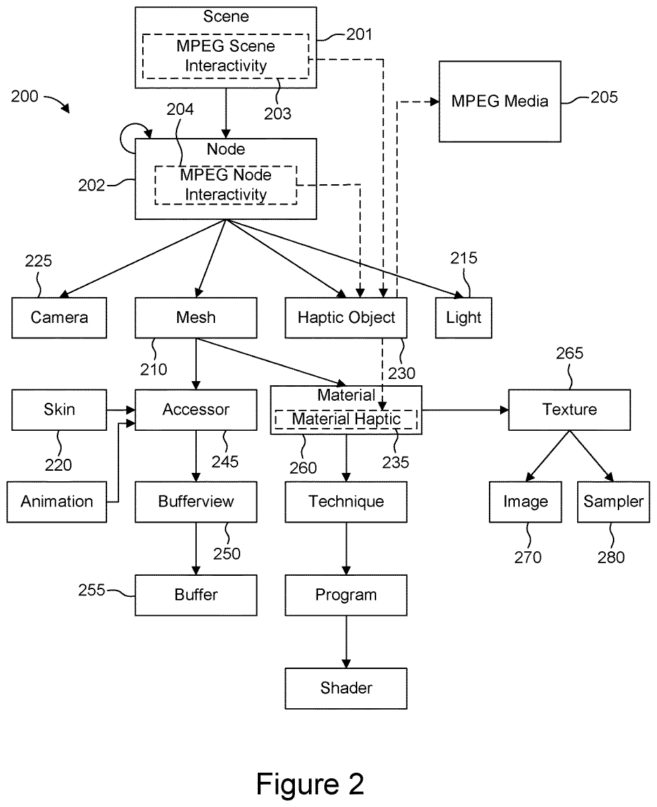

FIG. 2 illustrates an example of data structure of an immersive scene description for handling interactive haptic actions according to at least one embodiment. This embodiment is based on the glTF™ file format. The core of glTF™ is a JSON file that describes the structure and composition of a scene containing 3D models. The figure shows the relationship between the elements composing this data structure of an immersive scene description 200. In this context, a scene 201 is the top-level element gathering all the other elements. It comprises an array of nodes. Each node 202 can contain child nodes allowing to create a hierarchy. A node may refer to a mesh or camera or skin and a local geometrical transform may be associated with the node. A mesh 210 corresponds to the geometry data required to render the mesh. A skin 220 is used to perform vertex skinning to let vertices of a mesh be influenced by the bones of a skeleton based on its pose. A camera 225 determines a projection matrix. A light 215 determines the lighting properties associated with the node. Buffers 255 contain the data used for the geometry of 3D models, animations, and skinning. BufferViews 250 add structural information to the buffer data, while accessor 245 define the exact type and layout of BufferViews. Material 260 determines how an object should be rendered based on physical material properties. Texture 265 allows to define the appearance of an object. Images 270 define the image data used for a texture while a sampler 280 describes the wrapping and scaling of textures. Media files (for example audio WAV file for sound or haptic signals) may be combined in the MPEG media 205.

The immersive scene description file further comprises a haptic object 230 that describes a haptic effect to be rendered. A haptic object is identified in the file format as “MPEG_Haptic” and its syntax is further described below. A haptic object is attached at the node level to indicate that the node refers to haptic media and relies on independent haptic media like an audio content or an image. A haptic object may be associated with a material haptic 235, identified in the file format as “MPEG_material_haptics” that allows to define the haptic effect based on a texture 265.

The immersive scene description file further comprises an interactivity-related object, either located at the scene level (MPEG Scene Interactivity 203) or at the node level (MPEG Node Interactivity 204). Such interactivity-related objects allow to define interactions between the user and the immersive objects (nodes), thus creating a more animated immersive scene.

Other elements are conventional elements of an immersive representation and not related to embodiments, thus are not described herein.

Embodiments described herein aim to add haptic effects to the interactivity of an immersive scene and thus increase the quality of the user experience by allowing the user to physically sense the interactions through vibrations, heat, movements, etc.

According to embodiments, these elements of an immersive scene description file based on the glTF™ format allow to define an immersive scene with an interactive haptic action.

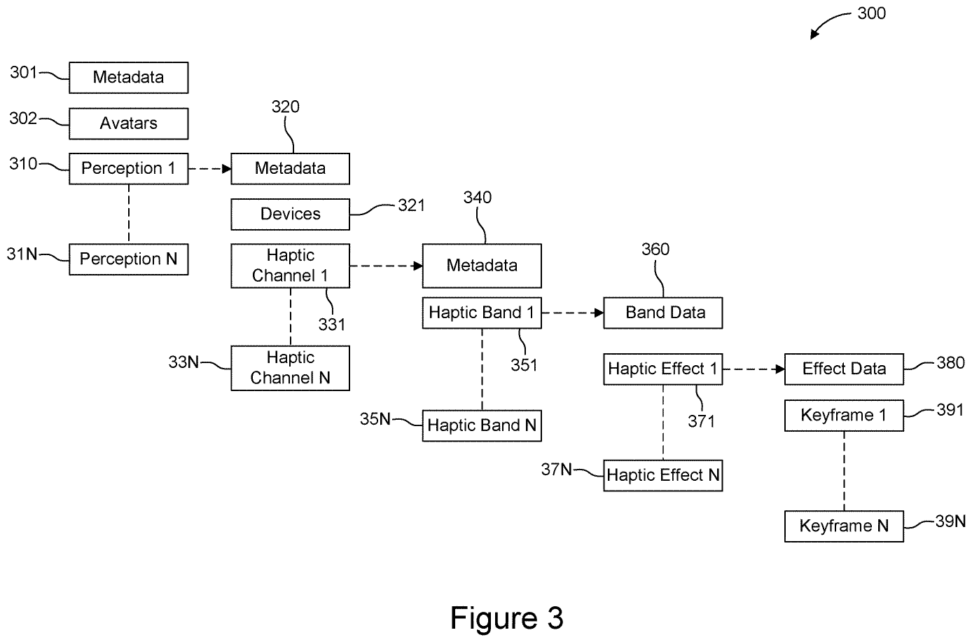

FIG. 3 illustrates an example of data structure for a haptic object. The data structure 300 represents a haptic object 230 of FIG. 2 and can be decomposed in a set of layers. At the upper layer, metadata 301 describe high-level metadata information regarding the overall haptic experience defined in the data structure 300 and a list of avatars 302 (i.e., body representation) later referenced in the file. These avatars allow to specify a target location of haptic stimuli on the body. The haptic effects are described through a list of perceptions 310, 31N. These perceptions correspond to haptic signals associated with specific perception modalities such as vibration, force, position, velocity, temperature, etc.). A perception comprises metadata 320 to describe parameters (such as the modality) of the haptic signal, devices 321 to describe specifications of a reference haptic device for which the signal was designed and a list of haptic channels 331, 33N. A haptic channel comprises metadata 340 to describe the content of the channel, the associated gain value, a mixing weight, body localization information and a reference to haptic device specification (defined at the perception level). The channel finally contains a list of haptic bands 351, 35N, each band defining a subset of the signal within a given frequency range. For example, the haptic band 351 may correspond to the range of frequencies from 0 to 50 Hz while the haptic band 35N may correspond to the range of frequencies over 2 kHz. A haptic band comprises band data 360 to describe the frequency range of the band, the type of encoding modality (Vectorial or Wavelet), the type of band (Transient, Curve and Wave) and optionally the type of curve interpolation (Cubic, Linear or unknown) or the window length. A haptic band is defined by a list of haptic effects 371, 37N. Finally, a haptic effect comprises a list of keyframes 391, 39N and effect data 380, a keyframe being defined by a position (i.e., a temporal reference), a frequency and an amplitude. The effect data describes the type of base signal selected amongst Sine, Square, Triangle, SawToothUp, and SawToothDown as well as provide temporal references such as timestamps. The low-level haptic signal can then be reconstructed based on the keyframes in the different bands.

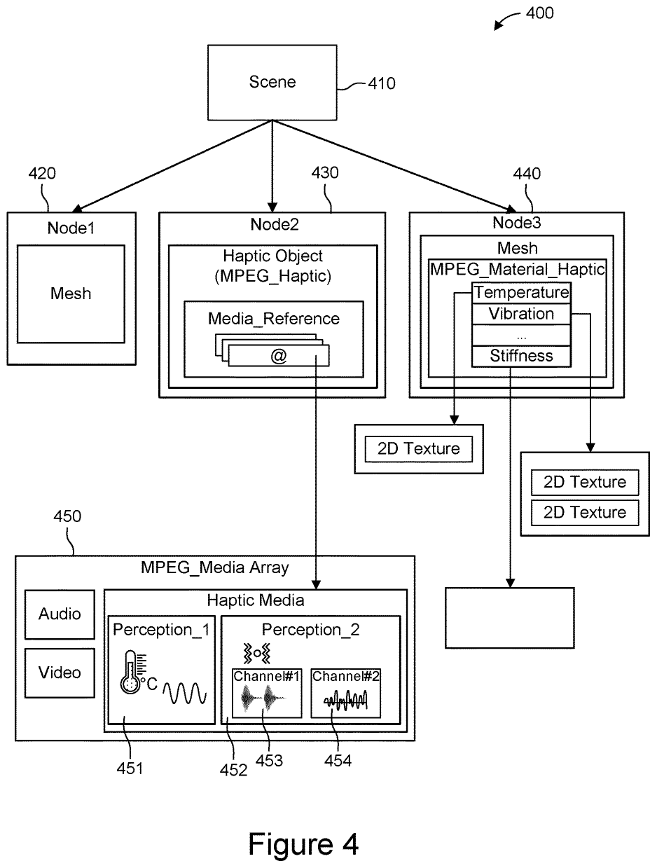

FIG. 4 illustrates an example of instantiation of a data structure for a haptic object. It represents an example of immersive scene description 400 and shows a practical use of the elements of FIGS. 2 and 3. In this example, the scene 410 comprises three nodes. The first node 420 is composed of a mesh representing a 3D object. The second 430 node comprises a haptic object (“MPEG_haptic” according to the standardized format) that comprises media references to haptic medias in the MPEG_media array 450. The haptic object thus comprises two haptic perceptions. The first perception 451 (“perception_1”) is related to a temperature effect (modality is set to “temperature”) and its value is defined using a transient band with the appropriate settings. The second perception 452 (“perception_2”) is related to a vibration effect (modality is set to “Vibrotactile”) and comprises two channels 453, 454 defined using wave bands based on keyframes. The third node 440 comprises a mesh representing a 3D object associated with a haptic texture (MPEG_material_haptic” according to the standardized format). The haptic texture is used to define multiple haptic effects. A temperature haptic effect is defined by an array of 2D textures with a single element, a vibration haptic effect is defined by an array of 2D textures. The other modalities (only stiffness is represented) are not used. Therefore, these modalities are associated with an empty array to specify that no haptic effect of these modalities is defined for this mesh.

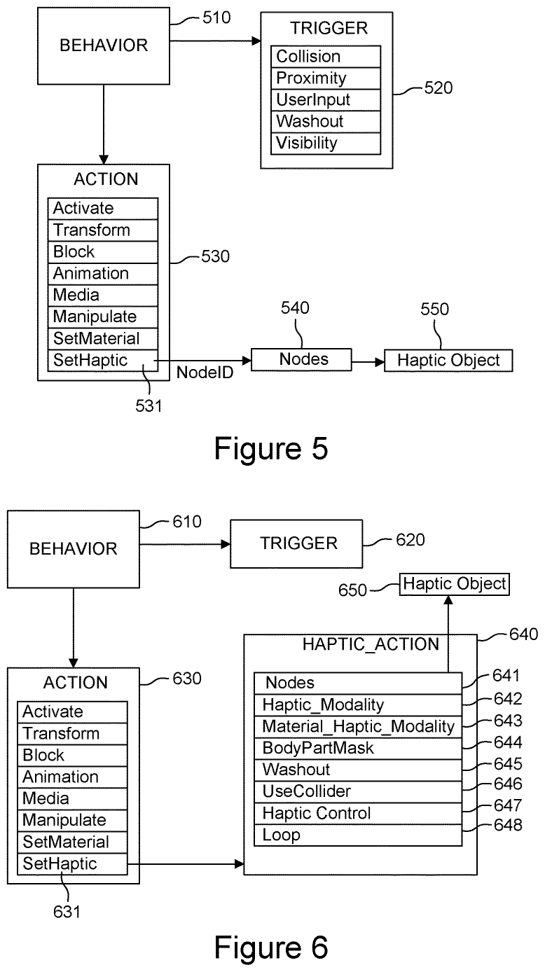

FIG. 5 illustrates a simple example of data structure for an interactive haptic action. At the top level, a behavior 510 corresponds to an interaction in the immersive world and is defined by a pair of triggers 520 and actions 530. A trigger determines when to perform an interaction and an action determines what to be done. Triggers and actions are further described below. A behavior is a combination of triggers using logical operators and related actions to be launched sequentially or in parallel. For example, a behavior can combine a proximity trigger with a media action, to start playing a specific media when the user gets within a given range of a specific object in the 3D scene. This could for example enable that, when the user approaches a virtual dog in the immersive scene, a dog barking sound is played. In addition to conventional actions, an interactive haptic action can be defined, through the use of an ACTION_SET_HAPTIC property 531. A simple formulation of this element is proposed in table 4. In such implementation, ACTION_SET_HAPTIC property comprises an array of indices of the nodes 540 in the nodes array to launch the haptic feedbacks defined in haptic objects 550 associated with the nodes, as previously described in FIGS. 3 and 4.

Behavior, triggers, and actions (including interactive haptic effects) are defined at the scene level using a MPEG scene interactivity 203 element of FIG. 2 and table 1 and are related to virtual objects of the immersive scene. Additional data may be provided at the level of the affected glTF™ nodes to specialize the trigger activation using a MPEG node interactivity 204 element of FIG. 2.

Table 1 describes the semantic of the MPEG_scene_interactivity element that comprises arrays of triggers, actions, and behaviors. In the tables below describing the semantic of elements, the first column determines the name of an element, the second column defines the type of data (here all elements are arrays), the third column defines if the element is mandatory (represented by ‘M’) or optional (represented by ‘O’), the fourth column defines the default value for the element (if any), and the last column describes the element.

TABLE 1

| Name | Type | Usage | Default | Description |
|---|---|---|---|---|
| triggers | Array | M | [ ] | Contains the definition of all the triggers used in that scene |
| actions | Array | M | [ ] | Contains the definition of all the actions used in that scene |
| behaviors | Array | M | [ ] | Contains the definition of all the behaviors used in that scene. |
| | | | | A behavior is composed of a pair of (triggers, actions), control |
| | | | | parameters of triggers and actions, a priority weight and an |
| | | | | optional interrupt action |

Different types of triggers are defined, comprising collision, proximity, user input and visibility to cover different aspects of triggering an action. Each type of trigger is associated with a set of properties that define the interaction. For instance, the proximity trigger specifies a distance range and a list of nodes associated with the trigger defining a distance or range wherein an action is triggered. Table 2 describes the semantic for the triggers.

TABLE 2

| Name | Type | Usage | Default | Description |
|---|---|---|---|---|
| type | string | M | “TRIGGER_COLLISION” | One element of Table 3 that defines the type of the |
| | | | | trigger. |
| If(type == | | | | |
| “TRIGGER_COLLISION”){ | | | | |
| nodes | Array | M | | Indices of the nodes in the nodes array to be |
| | | | | considered for collision determination. Any |
| | | | | detection of collision shall activate the trigger |
| } | | | | |
| If(type == | | | | |
| “TRIGGER_PROXIMITY”){ | | | | |
| distanceLowerLimit | Number | M | 0 | Threshold min in meters for the node proximity |
| | | | | calculation |
| distanceUpperLimit | Number | O | | Threshold max in meters for the node proximity |
| | | | | calculation |
| nodes | Array | M | [ ] | Indices of the nodes in the nodes array to be |
| | | | | considered. All the nodes shall have a distance |
| | | | | from the user camera above the |
| | | | | distanceLowerLimit and below the |
| | | | | distanceUpperLimit to activate the trigger |
| } | | | | |
| If(type== | | | | |
| “TRIGGER_USER_INPUT”){ | | | | |
| userInputDescription | String | M | | Describe the user body part and gesture related to |
| | | | | the input. E.g. “/user/hand/left/grip” |
| nodes | Array | O | | Indices of the nodes in the nodes array to be |
| | | | | considered for this user input |
| } | | | | |
| If(type== | | | | |
| “TRIGGER_VISIBILITY”){ | | | | |
| cameraNode | Number | M | | Index to the node containing a camera in the nodes |
| | | | | array for which the visibilities are determined |
| nodes | Array | M | | Indices of the nodes in the nodes array to be |
| | | | | considered. All the nodes shall be visible by the |
| | | | | camera to activate the trigger |
| } | | | | |

Table 3 defines the type of triggers.

TABLE 3

| Trigger type | Description |
|---|---|
| “TRIGGER_COLLISION” | Collision Trigger |
| “TRIGGER_PROXIMITY” | Proximity Trigger |
| “TRIGGER_USER_INPUT” | User_Input Trigger |
| “TRIGGER_VISIBILITY” | Visibility Trigger |

Different types of actions are defined, comprising to cover different types of action on a node, an animation, or a media. Each type of action is associated with a set of properties associated with the action. For example, the media action is specified through an index of a media (such as an audio file) in the MPEG media array and a media control allows to play or pause the selected media. Table 4 describes the semantic for the actions.

TABLE 4

| Name | Type | Usage | Default | Description |
|---|---|---|---|---|
| type | string | M | “ACTION_ACTIVATE” | One element of Table 5 that defines the type of |
| | | | | the action. |
| Delay | number | O | | Duration of delay in second before executing |
| | | | | the action |
| If (type== | | | | |
| ”ACTION_ACTIVATE”){ | | | | |
| activationStatus | enum | M | ENABLED | ENABLED = 0: the node shall be processed by |
| | | | | the application |
| | | | | DISABLED = 1: the node shall be skipped by |
| | | | | the application |
| nodes | array | M | [ ] | Indices of the nodes in the nodes array to set the |
| | | | | activation status |
| } | | | | |
| If(type== | | | | |
| “ACTION_TRANSFORM”) | | | | |
| { | | | | |
| transform | | M | | 4 × 4 transformation matrix to apply to the nodes |
| nodes | array | M | | Indices of the nodes in the nodes array to be |
| | | | | transformed |
| } | | | | |
| If(type== | | | | |
| “ACTION_BLOCK”){ | | | | |
| nodes | array | M | | Indices of the nodes in the nodes array to lock |
| | | | | their related transforms. |
| } | | | | |
| If(type == | | | | |
| “ACTION_ANIMATION”){ | | | | |
| animation | number | M | | index of the animation in the animations array |
| | | | | to be considered |
| animationControl | string | M | “ANIMATION_PLAY” | One element of Table 6 that defines the control |
| | | | | of the animation. |
| } | | | | |
| If (type == | | | | |
| “ACTION_MEDIA”){ | | | | |
| media | number | M | | Index of the media in the MPEG media array to |
| | | | | be considered |
| mediaControl | string | M | “MEDIA_PLAY” | One element of Table 7 that defines the control |
| | | | | of the media. |
| } | | | | |
| If (type == | | | | |
| “ACTION_MANIPULATE” | | | | |
| ){ | | | | |
| manipulate_action_type | string | M | “ACTION_MANIPULATE_FREE” | One element of Table 8 that defines the action |
| | | | | manipulate type. |
| Axis | array | O | up | (x, y, z) coordinates of the axis used for rotation |
| | | | | and sliding. These coordinates are relative to |
| | | | | the local space created by the USER_INPUT |
| | | | | trigger activation. E.g., a “/user/hand/left/pose” |
| | | | | user input trigger creates a local space attached |
| | | | | to the user left hand |
| nodes | array | M | | Indices of the nodes in the nodes array to be |
| | | | | manipulated. |
| } | | | | |
| If(type == | | | | |
| “ACTION_SET_MATERIA | | | | |
| L”){ | | | | |
| material | number | M | | Index of the material in the materials array to |
| | | | | apply to the nodes |
| nodes | array | M | | Indices of the nodes in the nodes array to set |
| | | | | their material |
| If(type == | | | | |
| “ACTION_SET_HAPTIC”){ | | | | |
| Nodes | Array | M | | Indices of the nodes in the nodes array to |
| | | | | launch their haptic feedbacks |
| } | | | | |

Table 5 defines the type of actions.

TABLE 5

| Action type | Description |
|---|---|
| “ACTION_ACTIVATE” | Set activation status of a node |
| “ACTION_TRANSFORM” | Set transform to a node |
| “ACTION_BLOCK” | Block the transform of a node |
| “ACTION_ANIMATION” | Select and control an animation |
| “ACTION_MEDIA” | Select and control a media |
| “ACTION_MANIPULATE” | Select a manipulate action |
| “ACTION_SET_MATERIAL” | Set new material to nodes |
| “ACTION_SET_HAPTIC” | Get haptic feedbacks on a set of nodes |

Table 6 defines the control of the animation for “ACTION_ANIMATION” elements.

TABLE 6

| Animation Control | Description |
|---|---|
| “ANIMATION_PLAY” | Play the animation |
| “ANIMATION_PAUSE” | Pause the animation |
| “ANIMATION_RESUME” | Resume the animation |
| “ANIMATION_STOP” | Stop the animation |

Table 7 defines the control of the media playback for “ACTION_MEDIA” elements.

TABLE 7

| Media Control | Description |
|---|---|
| “MEDIA_PLAY” | Play the media |
| “MEDIA_PAUSE” | Pause the media |
| “MEDIA_RESUME” | Resume the media |
| “MEDIA_STOP” | Stop the media |

Table 8 defines the type of manipulation action for “ACTION_MANIPULATE” elements.

TABLE 8

| Action Manipulate Type | description |
|---|---|
| “ACTION_MANIPULATE_FREE” | the nodes follow the user pointing device and its |
| | rotation |
| “ACTION_MANIPULATE_SLIDE” | the nodes move linearly along the provided axis by |
| | following the user pointing device |
| “ACTION_MANIPULATE_TRANSLATE” | the nodes translate by following the user pointing |
| | device |
| “ACTION_MANIPULATE_ROTATE” | the nodes rotate around the provided axis by |
| | following the user pointing device |
| “ACTION_MANIPULATE_SCALE” | performs a central scaling of the nodes by following |
| | the user pointing device |

A behavior is binding together a trigger and an action in order to provide a kind of animation at least one element of the immersive scene. Table 9 describes the semantic for the triggers.

TABLE 9

| Name | Type | Usage | Default | Description |
|---|---|---|---|---|
| triggers | array | M | | Indices of the triggers in the triggers array |
| | | | | considered for this behavior |
| actions | array | M | | Indices of the actions in the actions array |
| | | | | considered for this behavior |
| triggersCombinationControl | string | M | “” | Set of logical operations to apply to the |
| | | | | triggers |
| | | | | (eg “#1&!#2” means Trigger 1 and not |
| | | | | Trigger 2) |
| triggersActivationControl | string | M | “TRIGGER_ACTIVATE_FIRST_ENTER” | Indicates when the combination of the |
| | | | | triggers shall be activated for launching the |
| | | | | actions. One element of that Table 10 defines |
| | | | | the activation control of triggers. |
| actionsControl | enum | M | SEQUENTIAL | Defines the way to execute the defined |
| | | | | actions. |
| | | | | SEQUENTIAL = 0: each defined action is |
| | | | | executed sequentially in the order of the |
| | | | | actions array, |
| | | | | PARALLEL = 1: the defined actions are |
| | | | | executed concurrently |
| interruptAction | number | O | | Index of the action in the actions array to be |
| | | | | executed if the behavior is still on-going and |
| | | | | is no more defined in a newly received scene |
| | | | | update |
| priority | number | M | 0 | Weight associated with the behavior. Used to |
| | | | | select a behavior when several behaviors are |
| | | | | active at same time for one node |

Table 10 defines the different trigger activation controls.

TABLE 10

| Trigger Activation Control | Description |
|---|---|
| “TRIGGER_ACTIVATE_FIRST_ENTER” | activate when the conditions are first met |
| “TRIGGER_ACTIVATE_EACH_ENTER” | activate each time the conditions are met |
| “TRIGGER_ACTIVATE_ON” | activate as long as the conditions are met |
| “TRIGGER_ACTIVATE_FIRST” | activate when the conditions are first no longer met |
| “TRIGGER_ACTIVATE_EACH_EXIT” | activate each time the conditions are no longer met |
| “TRIGGER_ACTIVATE_OFF” | activate as long as the conditions are not met |

Table 11 describes the semantic of the MPEG_node_interactivity elements and allows to specialize the behavior for a given node.

TABLE 11

| Name | Type | Usage | Default | Description |
|---|---|---|---|---|
| type | string | M | “TRIGGER_COLLISION” | One element of Table 3 that defines the type of the |
| | | | | trigger |
| If(type == “TRIGGER_{—} | | | | |
| COLLISION”){ | | | | |
| collider | integer | M | N/A | the index of the mesh element that provides the |
| | | | | collider geometry for the current node. |
| | | | | The collider mesh may reference a material. |
| Static | boolean | M | True | For runtime processing optimization purpose, as a |
| | | | | Presentation Engine may optimize a collision |
| | | | | detection in the case of a static object (in contrary of |
| | | | | a dynamic one's) |
| usePhysics | Boolean | M | false | Indicates if the object shall be considered by the |
| | | | | physics simulation. |
| If (usePhysics) | | | | |
| { | | | | |
| useGravity | Boolean | M | true | Indicates if the gravity affects the object |
| mass | number | M | 1 | Mass of the object in kilogram. |
| Bounciness | number | M | 0.0 | Provides the amount that an object bounces in |
| | | | | response to a collision. The typical range is [0.0 1.0], |
| | | | | where 0.0 represents completely not bouncy and 1.0 |
| | | | | represents the maximum bounciest. |
| Roughness | number | M | 0.5 | Provides the roughness of an object which affects |
| | | | | how much the object moves in response to a |
| | | | | collision. The typical range is [0.0 1.0]. |
| } | | | | |
| } | | | | |
| If(type == “TRIGGER_{—} | | | | |
| PROXIMITY”){ | | | | |
| use_geocoordinates | Boolean | M | | Indicates if geo coordinates are used |
| If(use_geocoordinates){ | | | | |
| geo_coordinate | Number | M | N/A | Index to geo coordinate item in array in |
| | | | | MPEG_GEO_COORDINATES extension |
| } | | | | |
| allow_occlusion | Boolean | M | True | Indicates if occlusion by other nodes should be |
| | | | | considered |
| upper_distance_weight | number | O | 1 | The weight applied to the distanceUpperLimit |
| | | | | parameter defined at scene level |
| lower_distance_weight | number | O | 1 | The weight applied to the distanceLowerLimit |
| | | | | parameter defined at scene level |
| } | | | | |
| If(type ==”TRIGGER_{—} | | | | |
| USER_INPUT”){ | | | | |
| userInputParameters | array | M | [ ] | Provides additional information related to the user |
| | | | | inputs (eg “max speed = 0.5”) |
| } | | | | |
| If(type== “TRIGGER_{—} | | | | |
| VISIBILITY”){ | | | | |
| visibilityFull | boolean | M | True | Indicates if the visibility shall be full or partial to |
| | | | | activate the trigger |
| nodes | array | O | [ ] | Set of nodes that shall not be considered for the |
| | | | | visibility computation |
| mesh | number | O | | Index of the mesh in the scene meshes array that will |
| | | | | be used to compute visibility |
| } | | | | |

In at least one embodiment, an interactive haptic effect is implemented in an immersive scene description (191 in FIG. 1, 400 in FIG. 4) comprising haptic objects using the elements defined in the description of an action element as illustrated in the JSON schema of table 12.

```
TABLE 12
      “if”: {
        “properties”: { “type”: { “const”: “ACTION_ANIMATION” } },
        “required”: [“type”]
      },
      “then”: {
        “properties”: {
                      “animation”: { “type”: “integer”,“description”:“index of the animation in the
animations array to be considered ”},
                      “animationControl”:{“type”: “string”,
                      “description”:“defines the control of the animation.Value is oneOf
ANIMATION_PLAY, ANIMATION_PAUSE, ANIMATION_STOP, ANIMATION_RESUME
and can be extended”}
            },
        “required”: [“animation”,“animationControl”]
        }
    },
    {
        “if”: {
          “properties”: {“type”: { “const”: “ACTION_MEDIA” } },
          “required”: [“type”]
        },
        “then”: {
          “properties”: {
                        “media”: { “type”: “integer”,“description”:“Index of the media in the MPEG
media array to be considered”},
                        “mediaControl”:{“type”: “string”,
                        “description”:“defines the control of the animation.Value is oneOf
MEDIA_PLAY, MEDIA_PAUSE, MEDIA_STOP, MEDIA_RESUME and can be extended”}
              },
              “required”: [“media”,“mediaControl”]
          }
      },
      {
          “if”: {
            “properties”: { “type”: { “const”: “ACTION_MANIPULATE” } },
            “required”: [“type”]
          },
          “then”: {
            “properties”: {
                          “axis”: { “type”: “array”,“items”: {“type”:“number”},“minItems”:
3,“maxItems”: 3,“description”:“coordinates of the axis used for rotation and sliding”},
                          “manipulate_action_type”:{“type”: “string”,
                          “description”:“defines the control of the animation.Value is oneOf
ACTION_MANIPULATE_FREE, ACTION_MANIPULATE_SLIDE,
ACTION_MANIPULATE_TRANSLATE,
ACTION_MANIPULATE_ROTATE,ACTION_MANIPULATE_SCALE and can be extended”},
                          “nodes”: { “type”: “array”,
                                “items”:{“type”:“integer”},
                                “minItems”: 1,
                                “description”: “Indices of the nodes in the nodes array to be
manipulated.”}
                },
                “required”: [“manipulate_action_type”,“nodes”]
            }
        },
        {
            “if”: {
              “properties”: { “type”: { “const”: “ACTION_SET_MATERIAL” } },
              “required”: [“type”]
            },
            “then”: {
              “properties”: {
                            “material”: { “type”: “integer”,“description”:“Index of the material in the
materials array to apply to the nodes”},
                            “nodes”: { “type”: “array”,
                                  “items”:{“type”:“integer”},
                                  “minItems”: 1,
                                  “description”: “Indices of the nodes in the nodes array to set their
material”}
                  },
              “required”: [“material”,“nodes”]
              }
          },
          {
              “if”: {
                “properties”: { “type”: { “const”: “ACTION_SET_HAPTIC” } },
                “required”: [“type”]
              },
              “then”: {
                “properties”: {
                              “nodes”: { “type”: “array”,
                                    “items”:{“type”:“integer”},
                                    “minItems”: 1,
                                    “description”: “Indices of the nodes in the nodes array to launch their
haptic feedbacks”}
                    },
                “required”: [“nodes”]
                }
            }
  ],
  “required”:[“type”]
}
```

Embodiments herein describe different definitions the ACTION_SET_HAPTIC property. A simple formulation of this property is proposed above in the Tables 4 and 12. However, it has the drawback of only allowing to specify a list of nodes. This can be used to specify which node containing haptic data should be processed but is not sufficient to determine exactly how to process it. Indeed, a given node may be associated with multiple haptic files, each with potentially multiple haptic perceptions with different modalities and multiple haptic channels. The node may also contain a mesh associated with a haptic material that may reference multiple textures at different resolutions and with different haptic modalities. This formulation does not allow to specify how to process such a variety of haptic data, preventing the possibility to trigger separately haptic signals attached to the same object and thus limiting the design of haptic enabled interactive experience. For instance, in an immersive scene, the same haptic object may be used to render different types of haptic feedback at different moments. The designer of the experience may want to render vibration signals using a proximity trigger on the node while a friction map would be used with a collision trigger on this same node.

Embodiments below describe different variations of the syntax for the ACTION_SET_HAPTIC property of Table 4 to provide advanced haptic interactivity features, allowing to design precise haptic interactive experiences and produce precise and consistent haptic feedback through an accurate specification of the interactive haptic feedback. These embodiments propose to enable haptic interactions with objects of a scene, to explicitly target specific types of haptic signals, to explicitly target specific types of haptic materials, to explicitly target haptic media attached to a virtual object in the scene, to limit interactions to specific body parts, to trigger washout effects based on interactions. The proposed solutions provide interoperability for haptic device and for authoring tools, is compatible with the MPEG Haptic format (ISO/IEC 23090-31: Haptics Coding) and with existing haptic rendering methods.

FIG. 6 illustrates an example of data structure for an interactive haptic action according to a first embodiment. Similar to FIG. 5, the data structure comprises a behavior 610 defined by a pair of triggers 620 and actions 630. The difference with FIG. 5 is related to a new definition of the ACTION_SET_HAPTIC property 631. In this embodiment, in addition to the indices 641 of the nodes (in the nodes array) that comprise the haptic object 650, the ACTION_SET_HAPTIC property 631 specifies several additional elements for a haptic action 640: the modality 642 (type of haptic effect to be rendered), the modality for the haptic textures 643, a mask 644 specifying where on the body the effect could be rendered, a washout Boolean 645, a useCollider Boolean 646, a haptic control 647 to control the rendering of the haptic data, and a Loop Boolean 648. Table 13 describes the semantic of the ACTION_SET_HAPTIC property according to the first embodiment.

TABLE 13

| | | | | |
|---|---|---|---|---|
| If(type == “ACTION_{—} | | | | |
| SET_HAPTIC”){ | | | | |
| nodes | array | M | N/A | Indices of the nodes in the nodes array to launch |
| | | | | their haptic feedbacks |
| Haptic_Modality | Array<Enum> | M | N/A | List of haptic modalities that shall be rendered. |
| | | | | Possible values are described in table 14. If the list |
| | | | | contains one or more elements, only the Haptic |
| | | | | perceptions whose haptic modality is in the list |
| | | | | shall be rendered. If the list is empty, every Haptic |
| | | | | perception shall be rendered. |
| Material_Haptic_Modality | Array<Enum> | M | N/A | List of haptic material modalities that shall be |
| | | | | rendered. Possible values are detailed in Table 15 |
| Body PartMask | Integer | O | 0xFFFFFFFF | Body part mask specifying where on the body the |
| | | | | signal can be rendered. The list of body parts is |
| | | | | detailed in Table 16. Example of possible values |
| | | | | are given in Table 17. |
| Washout | Boolean | O | False | Specifies whether the action should trigger a |
| | | | | washout (reset to the origin or neutral position) of |
| | | | | the associated devices. |
| useCollider | Boolean | O | False | Used with a Collision trigger. If True, the |
| | | | | rendering engine shall use collision information to |
| | | | | estimate the desired location of the haptic feedback |
| | | | | on the body. If false, the signal shall be rendered |
| | | | | based on the information specified in the Haptic |
| | | | | file. |
| haptic_control | String | O | “HAPTIC_PLAY” | One element of Table 18 that defines the control |
| | | | | for the rendering of haptic data |
| loop | Boolean | O | False | Specifies if the rendering of the haptic data should |
| | | | | be continuously looping |
| } | | | | |

Two distinct fields are used to define the type of haptic. A Haptic_Modality field 642 defines the type of perception to be rendered for haptic medias attached directly to the node and a Material_Haptic_Modality field 643 defines the haptic modality to use for haptic textures attached to a mesh of the node and only comprises modalities that can be defined using textures.

The list of possible values for Haptic_Modality is detailed in Table 14 and corresponds to the list of possible perceptions specified in the ISO/IEC 23090-31: Haptics Coding standard. If no haptic modality is specified every type of haptic perception attached to the specified node shall be rendered.

TABLE 14
Haptic_Modality

Pressure
Acceleration
Velocity
Position
Temperature
Vibrotactile
Water
Wind
Force
Electrotactile
Vibrotactile Texture
Stiffness
Friction
Other

A list of possible values for Material_Haptic_Modality is detailed in Table 15 and matches the list of modalities specified in the Working Draft of the Amendment 2 of the MPEG Scene Description Standard.

TABLE 15
Haptic material modality

Stiffness
Friction
Vibrotactile Texture
Temperature
Vibration
Custom

If Material_Haptic_Modality is not empty, then only haptic materials will be rendered. If both the Haptic_Modality and Material_Haptic_Modality properties are not empty and if the haptic material references Haptic medias attached to the node (using a Reference texture), only haptic modalities specified in Haptic_Modality shall be rendered.

The BodyPartMask field may be used optionally to restrict the locations on the body where haptic effects shall be rendered. If no value is specified, the default value corresponds to the full body, i.e., no restrictions. The complete list of body parts is detailed in Table 16.

TABLE 16

| | Name | Body_part_mask (binary) | Hexadecimal |
|---|---|---|---|
| 0 | Unspecified | 00000000000000000000000000000000 | 0x00000000 |
| 1 | Head front | 00000000000000000000000000000001 | 0x00000001 |
| 2 | Head back | 00000000000000000000000000000010 | 0x00000002 |
| 3 | Head right | 00000000000000000000000000000100 | 0x00000004 |
| 4 | Head left | 00000000000000000000000000001000 | 0x00000008 |
| 5 | Right upper chest | 00000000000000000000000000010000 | 0x00000010 |
| 6 | Left upper chest | 00000000000000000000000000100000 | 0x00000020 |
| 7 | Abdomen | 00000000000000000000000001000000 | 0x00000040 |
| 8 | Waist | 00000000000000000000000010000000 | 0x00000080 |
| 9 | Upper back | 00000000000000000000000100000000 | 0x00000100 |
| 10 | Lower back | 00000000000000000000001000000000 | 0x00000200 |
| 11 | Right upper arm | 00000000000000000000010000000000 | 0x00000400 |
| 12 | Left upper arm | 00000000000000000000100000000000 | 0x00000800 |
| 13 | Right forearm | 00000000000000000001000000000000 | 0x00001000 |
| 14 | Left forearm | 00000000000000000010000000000000 | 0x00002000 |
| 15 | Right wrist | 00000000000000000100000000000000 | 0x00004000 |
| 16 | Left wrist | 00000000000000001000000000000000 | 0x00008000 |
| 17 | Right hand palm | 00000000000000010000000000000000 | 0x00010000 |
| 18 | Left hand palm | 00000000000000100000000000000000 | 0x00020000 |
| 19 | Right hand dorsum | 00000000000001000000000000000000 | 0x00040000 |
| 20 | Left hand dorsum | 00000000000010000000000000000000 | 0x00080000 |
| 21 | Right hand fingers | 00000000000100000000000000000000 | 0x00100000 |
| 22 | Left hand fingers | 00000000001000000000000000000000 | 0x00200000 |
| 23 | Right thigh | 00000000010000000000000000000000 | 0x00400000 |
| 24 | Left thigh | 00000000100000000000000000000000 | 0x00800000 |
| 25 | Right calf | 00000001000000000000000000000000 | 0x01000000 |
| 26 | Left calf | 00000010000000000000000000000000 | 0x02000000 |
| 27 | Right foot palm | 00000100000000000000000000000000 | 0x04000000 |
| 28 | Left foot palm | 00001000000000000000000000000000 | 0x08000000 |
| 29 | Right foot dorsum | 00010000000000000000000000000000 | 0x10000000 |
| 30 | Left foot dorsum | 00100000000000000000000000000000 | 0x20000000 |
| 31 | Right foot fingers | 01000000000000000000000000000000 | 0x40000000 |
| 32 | Left foot fingers | 10000000000000000000000000000000 | 0x80000000 |

Examples of combinations are illustrated in Table 17. For example, the left leg (4^{th} line) is made of the combination of the left foot fingers (0x80000000), left foot dorsum (0x20000000), left foot palm (0x08000000), left calf (0x02000000), and left thigh (0x00800000), leading to a combined value of 0xAA800000.

TABLE 17

| Name | Body_part_mask (binary) | Hexadecimal |
|---|---|---|
| Right arm | 00000000000101010101010000000000 | 0x00015540 |
| Left arm | 00000000001010101010100000000000 | 0x002AA800 |
| Right leg | 01010101010000000000000000000000 | 0x55400000 |
| Left leg | 10101010100000000000000000000000 | 0xAA800000 |
| Upper body | 00000000001111111111111111111111 | 0x003FFFFF |
| Lower body | 11111111110000000000000000000000 | 0xFFC00000 |
| Full body | 11111111111111111111111111111111 | 0xFFFFFFFF |

This haptic action can optionally trigger a washout of the associated haptic devices. A washout is used to reset a haptic device (a robot arm for instance) to its origin. Typically, it can be used in a game when changing environment or in an immersive experience when transitioning to a new scene.

A useCollider syntax element can optionally be set (Boolean value equal to true) to indicate that the rendering of the haptic feedback shall use collision information (such as the position of the collision on an avatar) to render the haptic feedback. When this flag is reset (Boolean value equal to false) it should only rely on the information provided in the haptic file. This field is only relevant when associated with a COLLISION trigger. For instance, a haptic file may contain haptic data for the whole body. If the collision is detected between the haptic object and a specific part of an avatar, the rendering should only be played on this part of the body if the useCollider option is setup.

The haptic_control property allows to control the rendering of the haptic data, as illustrated in Table 18. It can be used to start, pause, resume, or stop the rendering.

TABLE 18

| Haptic Control | Description |
|---|---|
| “HAPTIC_PLAY” | Start the rendering of the haptic data |
| “HAPTIC_PAUSE” | Pause the rendering of the haptic data |
| “HAPTIC_RESUME” | Resume the rendering of the haptic data |
| “HAPTIC_STOP” | Stop the rendering of the haptic data |

The loop property is optional and allows to specify whether the rendering of the haptic feedback should be looping (when set to true) or not looping (when set to false). If set to false, the haptic data will be played once. If true, the rendering may continue indefinitely. It can be stopped by triggering an action with a HAPTIC_STOP control on the same data. This is typically used through a behavior related to situations where the conditions are no longer met (i.e., elements of Table 10 such as TRIGGER_ACTIVATE_EACH_EXIT for example).

The JSON schema corresponding to the first embodiment is defined in Table 19, showing an updated syntax for the ACTION_SET_HAPTIC element. Other elements are unchanged with regards to Table 12.

```
TABLE 19
{
  “if”:{
    “properties”:{
      “type”:{
        “const”:“ACTION_SET_HAPTIC”
      }
    },
    “required”:[
      “type”
    ]
  },
  “then”:{
    “properties”:{
      “nodes”:{
        “type”:“array”,
        “items”:{
          “type”:“integer”
        },
        “minItems”:1,
        “description”:“Indices of the nodes in the nodes array to launch their haptic feedbacks”
      },
      “haptic_modality”:{
        “type”:“array”,
        “items”:{
          “type”:“string”,
          “enum”:[
            “Pressure”,
            “Acceleration”,
            “Velocity”,
            “Position”,
            “Temperature”,
            “Vibrotactile”,
            “Water”,
            “Wind”,
            “Force”,
            “Electrotactile”,
            “Vibrotactile Texture”,
            “Stiffness”,
            “Friction”,
            “Other”
          ],
          “description”:“List of haptic modalities that shall be rendered.”
        }
      },
      “material_haptic_modality”:{
        “type”:“array”,
        “items”:{
          “type”:“string”,
          “enum”:[
            “Stiffness”,
            “Friction”,
            “Vibrotactile Texture”,
            “Temperature”,
            “Vibration”,
            “Custom”
          ],
          “description”:“List of haptic material modalities that shall be rendered.”
        }
      },
      “body_part_mask”:{
        “type”:“integer”,
        “description”:“Binary mask specifying body parts where the haptic signal can be
rendered.”,
        “minimum”:0
      },
      “washout”:{
        “type”:“boolean”,
        “description”:“Specifies whether the action should trigger a washout (reset to the origin
or neutral position) of the associated devices.”
      },
      “useCollider”:{
        “type”:“boolean”,
        “description”:“Used with a Collision trigger. If True, the rendering engine shall use
collision information to estimate the desired location of the haptic feedback on the body. If false,
the signal shall be rendered based on the information specified in the Haptic file..”
      },
      “haptic_control”:{
        “type”:“string”,
        “enum”:[
            “HAPTIC_PLAY”,
            “HAPTIC_PAUSE”,
            “HAPTIC_RESUME”,
            “HAPTIC_STOP”
          ],
        “description”:“defines the control for the rendering of haptic data.”,
        “default”: “HAPTIC_PLAY”
      },
      “loop”:{
        “type”:“boolean”,
        “description”:“Specifies if the rendering of the haptic data should be continuously
looping.”,
        “default”:false
      }
    },
    “required”: [
      “nodes”,
      “haptic_modality”,
      “material_haptic_modality”
    ]
  }
}
```

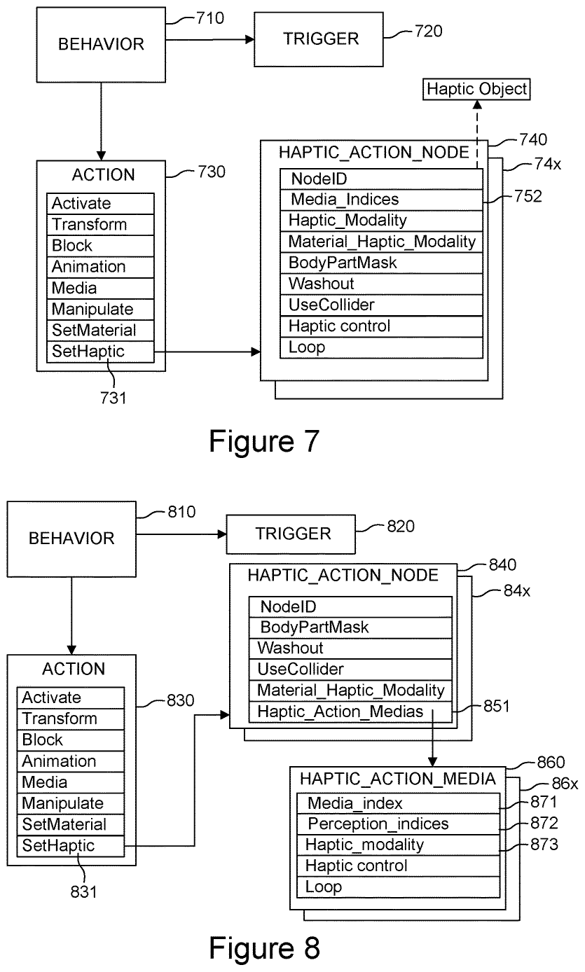

FIG. 7 illustrates an example of data structure for an interactive haptic action according to a second embodiment. Similar to the FIG. 5, the data structure comprises a behavior 710 defined by a pair of triggers 720 and actions 730. The difference with FIG. 5 is related to a new definition of the ACTION_SET_HAPTIC property 731. This second embodiment proposes a more precise approach allowing to specify which haptic media should be rendered for a given node. An ACTION_SET_HAPTIC defines a list of Haptic_action_nodes 740, 74x as shown in Table 20.

TABLE 20

| | | | | |
|---|---|---|---|---|
| If(type == | | | | |
| “ACTION_SET_HAPTIC”){ | | | | |
| Haptic_action_nodes | Array<Haptic_Action_Node> | M | N/A | List of haptic action nodes |
| } | | | | |

The individual properties of Haptic_action_nodes are described in Table 21. They comprise a media_indices property 752 that corresponds to a list of indices of the media in the Media_reference array attached to the node through the MPEG_Haptic extension. The other properties are identical to the properties of the first embodiment but are defined individually for each node identified by its nodeID (or node index), resulting into a finer definition of the haptic effect.

TABLE 21

| Property | Type | Required | Default | Description |
|---|---|---|---|---|
| node | Integer | M | N/A | Index of the node in the nodes array to |
| | | | | launch their haptic feedbacks |
| media_indices | Array<Integer> | M | N/A | Indices in the Media_reference array of |
| | | | | the MPEG_haptic extension. If the list |
| | | | | contains one or more elements, only the |
| | | | | medias in the list shall be rendered. If the |
| | | | | list is empty, every media can be rendered. |
| Haptic_Modality | Array<Enum> | M | N/A | List of haptic modalities that shall be |
| | | | | rendered. Possible values are described in |
| | | | | Table 14. If the list contains one or more |
| | | | | elements, only the Haptic perceptions |
| | | | | whose haptic modality is in the list shall be |
| | | | | rendered. If the list is empty, every Haptic |
| | | | | perception can be rendered. |
| Material_Haptic_Modality | Array<Enum> | M | N/A | List of haptic material modalities that shall |
| | | | | be rendered. Possible values are detailed in |
| | | | | Table 15. If the list is empty, every |
| | | | | material Haptic modality can be rendered. |
| BodyPartMask | Integer | O | 0xFFFFFFFF | Body part mask specifying where on the |
| | | | | body the signal can be rendered. |
| Washout | Boolean | O | False | Specifies whether the action should trigger |
| | | | | a washout (reset to the origin or neutral |
| | | | | position) of the associated devices. |
| useCollider | Boolean | O | False | Used with a Collision trigger. If True, the |
| | | | | rendering engine shall use collision |
| | | | | information to estimate the desired |
| | | | | location of the haptic feedback on the |
| | | | | body. If false, the signal shall be rendered |
| | | | | based on the information specified in the |
| | | | | Haptic file. |
| haptic_control | String | O | “HAPTIC_PLAY” | One element of Table 18 that defines the |
| | | | | control for the rendering of haptic data. |
| loop | Boolean | O | False | Specifies if the rendering of the haptic data |
| | | | | should be continuously looping |

The JSON schema corresponding to the second embodiment is defined in Table 22, showing an updated syntax for the ACTION_SET_HAPTIC element. Other elements are unchanged with regards to Table 12.

```
TABLE 22
{
  “if”:{
    “properties”:{
      “type”:{
        “const”:“ACTION_SET_HAPTIC”
      }
    },
    “required”:[
      “type”
    ]
  },
  “then”:{
    “properties”:{
      “haptic_action_nodes”:{
        “type”:“array”,
        “items”:{
          “type”:“object”,
          “properties”:{
            “node”:{
              “type”:“integer”,
              “description”:“Index of the node in the nodes array to launch their haptic feedbacks”
            },
            “media_indices”:{
              “type”:“array”,
              “items”:{
                “type”:“integer”
              },
              “description”:“Indices in the Media_reference array of the MPEG_haptic extension.”
            },
            “haptic_modality”:{
              “type”:“array”,
              “items”:{
                “type”:“string”,
                “enum”:[
                  “Pressure”,
                  “Acceleration”,
                  “Velocity”,
                  “Position”,
                  “Temperature”,
                  “Vibrotactile”,
                  “Water”,
                  “Wind”,
                  “Force”,
                  “Electrotactile”,
                  “Vibrotactile Texture”,
                  “Stiffness”,
                  “Friction”,
                  “Other”
                ],
                “description”:“List of haptic modalities that can be rendered.”
              }
            },
            “material_haptic_modality”:{
              “type”:“array”,
              “items”:{
                “type”:“string”,
                “enum”:[
                  “Stiffness”,
                  “Friction”,
                  “Vibrotactile Texture”,
                  “Temperature”,
                  “Vibration”,
                  “Custom”
                ],
                “description”:“List of haptic material modalities that shall be rendered.”
              }
            },
            “body_part_mask”:{
              “type”:“integer”,
              “description”:“Binary mask specifying body parts where the haptic signal can be rendered.”,
              “minimum”:0
            },
            “washout”:{
              “type”:“boolean”,
              “description”:“Specifies whether the action should trigger a washout (reset to the origin or neutral
position) of the associated devices.”
            },
            “useCollider”:{
              “type”:“boolean”,
              “description”:“Used with a Collision trigger. If True, the rendering engine shall use collision information
to estimate the desired location of the haptic feedback on the body. If false, the signal shall be rendered based on the
information specified in the Haptic file..”
            },
            “haptic_control”:{
              “type”:“string”,
              “enum”:[
                  “HAPTIC_PLAY”,
                  “HAPTIC_PAUSE”,
                  “HAPTIC_RESUME”,
                  “HAPTIC_STOP”
                ],
              “description”:“defines the control for the rendering of haptic data.”,
              “default”: “HAPTIC_PLAY”
            },
            “loop”:{
              “type”:“boolean”,
              “description”:“Specifies if the rendering of the haptic data should be continuously looping.”,
              “default”:false
            }
          },
          “required”:[
            “node”,
            “media_indices”,
            “haptic_modality”,
            “material_haptic_modality”
          ]
        },
        “minItems”:1,
        “description”:“List of haptic action nodes ”
      }
    },
    “required”:[
      “haptic_action_nodes”
    ]
  }
}
```

FIG. 8 illustrates an example of data structure for an interactive haptic action according to a third embodiment. Similar to the FIG. 5, the data structure comprises a behavior 810 defined by a pair of triggers 820 and actions 830. The difference from FIG. 5 is related to a new definition of the ACTION_SET_HAPTIC property 831. This third embodiment proposes a more precise solution that allows to specify which perception of which media should be rendered for a given list of nodes. This solution is hierarchical and allows to select data more accurately from the haptic data structure through the introduction of a HAPTIC_ACTION_MEDIA property 840, 84x. Instead of only specifying the type of modality that shall be rendered, the solution allows to explicitly specify which perception to render based on its identifier.

The nodeID, Body_Part_Mask, the washout, the useCollider and the Material_Haptic_Modality property are identical to the previous embodiments. In this embodiment, the Haptic_Modality field is now provided at the media level and is optional.

For that purpose, a list of HAPTIC_ACTION_MEDIA 851 provides access to one or several haptic action media elements 860, 86x. These elements comprise an index of a media 871, one or several indices of perception 872 and one or several indices of modality 873.

In addition to the perception_indices list, the Haptic_Modality property can also be used similarly to the previous embodiment to limit the rendering to the perceptions that match the specified modalities and ignore the others.

Tables 23, 24 and 25 respectively illustrate the new definitions according to the third embodiment for the ACTION_SET_HAPTIC property, for a HAPTIC_ACTION_NODE and a HAPTIC_ACTION_MEDIA.

TABLE 23

| | | | | |
|---|---|---|---|---|
| If(type == | | | | |
| “ACTION_SET_HAPTIC”){ | | | | |
| Haptic_action_nodes | Array<Haptic_Action_Node> | M | N/A | List of haptic action nodes |
| } | | | | |

TABLE 24

| Property | Type | Required | Default | Description |
|---|---|---|---|---|
| node | Integer | M | N/A | Index of the node in the nodes array to launch |
| | | | | their haptic feedbacks |
| BodyPartMask | Integer | O | 0xFFFFFFFF | Body part mask specifying where on the body |
| | | | | the signal can be rendered. |
| Washout | Boolean | O | False | Specifies whether the action should trigger a |
| | | | | washout (reset to the origin or neutral |
| | | | | position) of the associated devices. |
| useCollider | Boolean | O | False | Used with a Collision trigger. If True, the |
| | | | | rendering engine shall use collision |
| | | | | information to estimate the desired location of |
| | | | | the haptic feedback on the body. If false, the |
| | | | | signal shall be rendered based on the |
| | | | | information specified in the Haptic file. |
| Material_Haptic_Modality | Array<Enum> | M | N/A | List of haptic material modalities that can be |
| | | | | rendered. Possible values are detailed in Table |
| | | | | 15. If the list is empty, every material Haptic |
| | | | | modality can be rendered. |
| Haptic_action_medias | Array<Haptic_Action_Media> | M | N/A | List of Haptic_Action_Media |

TABLE 25

| Property | Type | Required | Default | Description |
|---|---|---|---|---|
| Media_index | Integer | M | N/A | Index in the Media_reference array of the |
| | | | | MPEG_haptic extension. |
| perception_indices | Array<Integer> | M | N/A | Indices of the perceptions of the media that shall be |
| | | | | rendered. If the list is empty, all perceptions shall be |
| | | | | rendered |
| Haptic_Modality | Array<Enum> | M | N/A | List of haptic modalities that can be rendered. |
| | | | | Possible values are described in Table 14. If the list |
| | | | | contains one or more elements, only the Haptic |
| | | | | perceptions whose haptic modality is in the list shall |
| | | | | be rendered. If the list is empty, every Haptic |
| | | | | perception can be rendered. |
| haptic_control | String | O | “HAPTIC_PLAY” | One element of Table 18 that defines the control for |
| | | | | the rendering of haptic data. |
| loop | Boolean | O | False | Specifies if the rendering of the haptic data should |
| | | | | be continuously looping |

The JSON schema corresponding to the third embodiment is defined in Table 26, showing an updated syntax for the ACTION_SET_HAPTIC element. Other elements are unchanged with regards to Table 12.

```
TABLE 26
{
  “if”:{
    “properties”:{
      “type”:{
        “const”:“ACTION_SET_HAPTIC”
      }
    },
    “required”:[
      “type”
    ]
  },
  “then”:{
    “properties”:{
      “haptic_action_nodes”:{
        “type”:“array”,
        “items”:{
          “type”:“object”,
          “properties”:{
            “node”:{
              “type”:“integer”,
              “description”:“Index of the node in the nodes array to launch their haptic feedbacks”
            },
            “material_haptic_modality”:{
              “type”:“array”,
              “items”:{
                “type”:“string”,
                “enum”:[
                  “Stiffness”,
                  “Friction”,
                  “Vibrotactile Texture”,
                  “Temperature”,
                  “Vibration”,
                  “Custom”
                ],
                “description”:“List of haptic material modalities that shall be rendered.”
              }
            },
            “body_part_mask”:{
              “type”:“integer”,
              “description”:“Binary mask specifying body parts where the haptic signal can be rendered.”,
              “minimum”:0
            },
            “washout”:{
              “type”:“boolean”,
              “description”:“Specifies whether the action should trigger a washout (reset to the origin or neutral
position) of the associated devices.”
            },
            “useCollider”:{
              “type”:“boolean”,
              “description”:“Used with a Collision trigger. If True, the rendering engine shall use collision information
to estimate the desired location of the haptic feedback on the body. If false, the signal shall be rendered based on the
information specified in the Haptic file..”
            },
            “haptic_action_medias”:{
              “description”:“List of haptic medias that shall be rendered with their associated properties.”,
              “type”:“array”,
              “items”:{
                “type”:“object”,
                “properties”:{
                  “media_index”:{
                    “type”:“integer”,
                    “description”:“Index in the Media_reference array of the MPEG_haptic extension.”
                  },
                  “perception_indices”:{
                    “type”:“array”,
                    “items”:{
                      “type”:“integer”
                    },
                    “description”:“Indices of the perceptions of the media that shall be rendered. If the list is empty,
all perceptions shall be rendered.”
                  },
                  “haptic_modality”:{
                    “type”:“array”,
                    “items”:{
                      “type”:“string”,
                      “enum”:[
                        “Pressure”,
                        “Acceleration”,
                        “Velocity”,
                        “Position”,
                        “Temperature”,
                        “Vibrotactile”,
                        “Water”,
                        “Wind”.
                        “Force”,
                        “Electrotactile”,
                        “Vibrotactile Texture”,
                        “Stiffness”,
                        “Friction”,
                        “Other”
                      ],
                      “description”:“List of haptic modalities that can be rendered.”
                    }
                  },
                  “haptic_control”:{
                    “type”:“string”,
                    “enum”:[
                        “HAPTIC_PLAY”,
                        “HAPTIC_PAUSE”,
                        “HAPTIC_RESUME”,
                        “HAPTIC_STOP”
                      ],
                    “description”:“defines the control for the rendering of haptic data.”,
                    “default”: “HAPTIC_PLAY”
                  },
                  “loop”:{
                    “type”:“boolean”,
                    “description”:“Specifies if the rendering of the haptic data should be continuously looping.”,
                    “default”:false
                  }
                },
                “required”:[
                  “media_index”,
                  “perception_indices”,
                  “haptic_modality”
                ]
              }
            }
          },
          “required”:[
            “node”,
            “haptic_action_medias”,
            “material_haptic_modality”
          ]
        },
        “minItems”:1,
        “description”:“List of haptic action nodes ”
      }
    },
    “required”:[
      “haptic_action_nodes”
    ]
  }
}
```

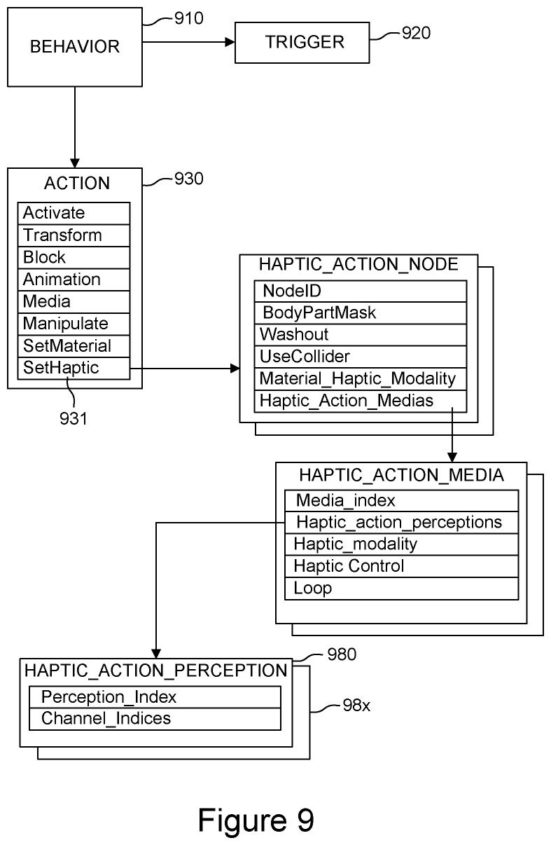

FIG. 9 illustrates an example of data structure for an interactive haptic action according to a fourth embodiment. Similar to the FIG. 5, the data structure comprises a behavior 910 defined by a pair of triggers 920 and actions 930. The difference with FIG. 5 is related to a new definition of the ACTION_SET_HAPTIC property 931. This third embodiment extends the hierarchical construct of the third embodiment and goes one step deeper into the haptic data structure to explicitly define which haptic channel of which perception shall be rendered through the introduction of a HAPTIC_ACTION_PERCEPTION property 980, 98x.

Tables 27, 28, 29 and 30 respectively illustrate the new definitions according to the third embodiment for the ACTION_SET_HAPTIC property, a HAPTIC_ACTION_NODE, a HAPTIC_ACTION_MEDIA and a HAPTIC_ACTION_PERCEPTION.

TABLE 27

| | | | | |
|---|---|---|---|---|
| If(type == | | | | |
| “ACTION_SET_HAPTIC”){ | | | | |
| Haptic_action_nodes | Array<Haptic_Action_Node> | M | N/A | List of haptic action nodes |
| } | | | | |

TABLE 28

| Property | Type | Required | Default | Description |
|---|---|---|---|---|
| Node | Integer | M | N/A | Index of the node in the nodes array to launch |
| | | | | their haptic feedbacks |
| BodyPartMask | Integer | O | 0xFFFFFFFF | Body part mask specifying where on the body |
| | | | | the signal can be rendered. |
| Washout | Boolean | O | False | Specifies whether the action should trigger a |
| | | | | washout (reset to the origin or neutral |
| | | | | position) of the associated devices. |
| useCollider | Boolean | O | False | Used with a Collision trigger. If True, the |
| | | | | rendering engine shall use collision |
| | | | | information to estimate the desired location of |
| | | | | the haptic feedback on the body. If false, the |
| | | | | signal shall be rendered based on the |
| | | | | information specified in the Haptic file. |
| Material_Haptic_Modality | Array<Enum> | M | N/A | List of haptic material modalities that can be |
| | | | | rendered. Possible values are detailed in Table |
| | | | | 15. If the list is empty, every material Haptic |
| | | | | modality can be rendered. |
| Haptic_action_medias | Array<Haptic_Action_Media> | M | N/A | List of Haptic_Action_Media |

TABLE 29

| Property | Type | Required | Default | Description |
|---|---|---|---|---|
| Media_index | Integer | M | N/A | Index in the Media_reference array |
| | | | | of the MPEG_haptic extension. |
| Haptic_action_perceptions | Array<Haptic_Action_Perception> | M | N/A | List of haptic perceptions that |
| | | | | shall be rendered with their |
| | | | | associated properties. If the |
| | | | | list is empty, all perceptions |
| | | | | shall be rendered. |
| Haptic_Modality | Array<Enum> | M | N/A | List of haptic modalities that |
| | | | | can be rendered. Possible values |
| | | | | are described in Table 14. If the |
| | | | | list contains one or more elements, |
| | | | | only the Haptic perceptions whose |
| | | | | haptic modality is in the list shall |
| | | | | be rendered. If the list is empty, |
| | | | | every Haptic perception can be |
| | | | | rendered. |
| haptic_control | String | O | “HAPTIC_PLAY” | One element of Table 18 that defines |
| | | | | the control for the rendering of |
| | | | | haptic data. |
| loop | Boolean | O | False | Specifies if the rendering of the |
| | | | | haptic data should be continuously |
| | | | | looping |

TABLE 30

| Property | Type | Required | Default | Description |
|---|---|---|---|---|
| Perception_index | Integer | M | N/A | Index of the perception of the media that shall be |
| | | | | rendered. |
| channel_indices | Array<Integer> | M | N/A | Indices of the channels of the perception that shall be |
| | | | | rendered. If the list if empty, all channels shall be |
| | | | | rendered |

The JSON schema corresponding to the fourth embodiment is defined in Table 31, showing an updated syntax for the ACTION_SET_HAPTIC element. Other elements are unchanged with regards to Table 12.

```
TABLE 31
{
  “if”:{
    “properties”:{
      “type”:{
        “const”:“ACTION_SET_HAPTIC”
      }
    },
    “required”:[
      “type”
    ]
  },
  “then”:{
    “properties”:{
      “haptic_action_nodes”:{
        “type”:“array”,
        “items”:{
          “type”:“object”,
          “properties”:{
            “node”:{
              “type”:“integer”,
              “description”:“Index of the node in the nodes array to launch their haptic feedbacks”
            },
            “material_haptic_modality”:{
              “type”:“array”,
              “items”:{
                “type”:“string”,
                “enum”:[
                  “Stiffness”,
                  “Friction”,
                  “Vibrotactile Texture”,
                  “Temperature”,
                  “Vibration”,
                  “Custom”
                ],
                “description”:“List of haptic material modalities that shall be rendered.”
              }
            },
            “body_part_mask”:{
              “type”:“integer”,
              “description”:“Binary mask specifying body parts where the haptic signal can be rendered.”,
              “minimum”:0
            },
            “washout”:{
              “type”:“boolean”,
              “description”:“Specifies whether the action should trigger a washout (reset to the origin or neutral
position) of the associated devices.”
            },
            “useCollider”:{
              “type”:“boolean”,
              “description”:“Used with a Collision trigger. If True, the rendering engine shall use collision information
to estimate the desired location of the haptic feedback on the body. If false, the signal shall be rendered based on the
information specified in the Haptic file..”
            },
            “haptic_action_medias”:{
              “description”:“List of haptic medias that shall be rendered with their associated properties.”,
              “type”:“array”,
              “items”:{
                “type”:“object”,
                “properties”:{
                  “media_index”:{
                    “type”:“integer”,
                    “description”:“Index in the Media_reference array of the MPEG_haptic extension.”
                  },
                  “haptic_modality”:{
                    “type”:“array”,
                    “items”:{
                      “type”:“string”,
                      “enum”:[
                        “Pressure”,
                        “Acceleration”,
                        “Velocity”,
                        “Position”,
                        “Temperature”,
                        “Vibrotactile”,
                        “Water”,
                        “Wind”,
                        “Force”,
                        “Electrotactile”,
                        “Vibrotactile Texture”,
                        “Stiffness”,
                        “Friction”,
                        “Other”
                      ],
                      “description”:“List of haptic modalities that can be rendered.”
                    }
                  },
                  “haptic_action_perception”:{
                    “type”:“array”,
                    “description”:“List of haptic perceptions that shall be rendered with their associated properties. If
the list is empty, all perceptions shall be rendered.”,
                    “items”:{
                      “type”:“object”,
                      “properties”:{
                        “perception_index”:{
                          “type”:“integer”,
                          “description”:“Index of the perception of the media that shall be rendered. If the list is
empty, all perceptions shall be rendered.”
                        },
                        “channel_indices”:{
                          “type”:“array”,
                          “items”:{
                            “type”:“integer”
                          },
                          “description”:“Indices of the channels of the perception that shall be rendered. If the list if
empty all channels shall be rendered.”
                        }
                      },
                      “required”:[
                        “perception_index”,
                        “channel_indices”
                      ]
                    }
                  },
                  “haptic_control”:{
                    “type”:“string”,
                    “enum”:[
                        “HAPTIC_PLAY”,
                        “HAPTIC_PAUSE”,
                        “HAPTIC_RESUME”,
                        “HAPTIC_STOP”
                      ],
                    “description”:“defines the control for the rendering of haptic data.”,
                    “default”: “HAPTIC_PLAY”
                  },
                  “loop”:{
                    “type”:“boolean”,
                    “description”:“Specifies if the rendering of the haptic data should be continuously looping.”,
                    “default”:false
                  }
                },
                “required”:[
                  “media_index”,
                  “haptic_modality”,
                  “haptic_action_perception”
                ]
              }
            }
          },
          “required”:[
            “node”,
            “haptic_action_medias”,
            “material_haptic_modality”
          ]
        },
        “minItems”:1,
        “description”:“List of haptic action nodes ”
      }
    },
    “required”:[
      “haptic_action_nodes”
    ]
  }
}
```

Embodiments introduced above are hereafter further described in an application related to a simple use case for enhancing a simple immersive experience by adding haptic data to elements of the scene. The immersive scene is a virtual car show room with several car models displayed. A user can move within the virtual show room and interact with the virtual objects. For example, when the user touches a door, the door opens to reveal the interior of the car. When a user looks at a car from a distance, it virtually starts the engine of the car and triggers the rendering of an audio content representing the sound of the engine.

In addition to these conventional interactive actions, the experience can be enhanced by using different perception modalities: virtual elements of the virtual show room may be associated with haptic effects. The following figures show examples of such interactive haptic action according to the four embodiments. These examples are somehow simplified for the sake of simplicity of the drawing. Indeed, a quality rendering of a 3D object requires much more elements than just a mesh.

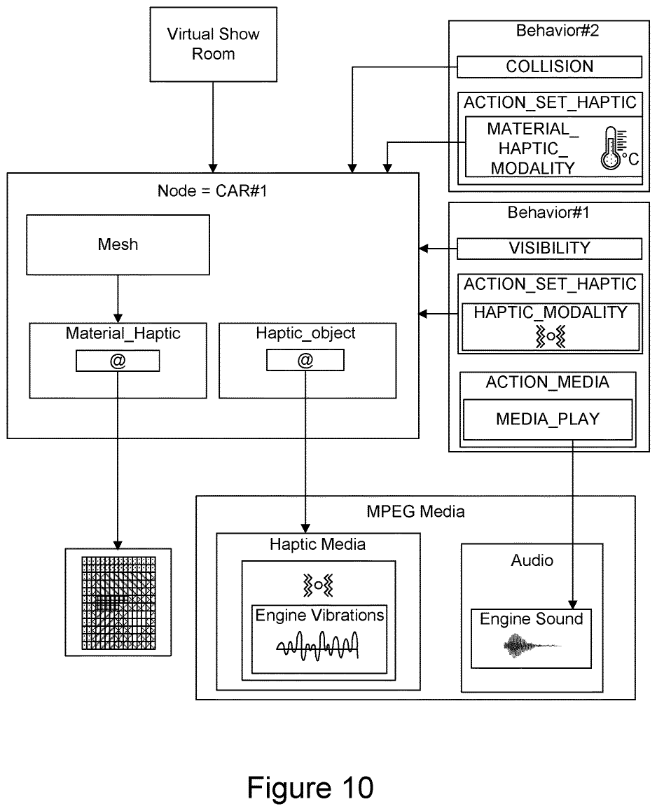

FIG. 10 shows an example of architecture of a scene description comprising an interactive haptic action according to the first embodiment. In a first example, in addition to the engine sound, a vibration is triggered when the engine is virtually started (i.e., when the car becomes visible to the user) and an increase of the temperature would be felt by the user on different areas of the car. A temperature map could be attached to the mesh of the car to represent the temperature distribution on the body of the car (hotter near the engine). When using the first embodiment, such interactive haptic action can be defined using a scene description comprising a CAR #1 node, a haptic media defining the sound of the engine (for example a WAV file), a haptic media defining the vibrations of the running engine (a vibrotactile perception), a haptic material representing the texture map for the temperature of the car, and two haptic behaviors. The first, Behavior #1, comprises a VISIBILITY trigger referencing the car node, an ACTION_SET_HAPTIC action referencing the car node and with the array Haptic_Modality property set to “Vibrotactile” and an ACTION_MEDIA property set to MEDIA-PLAY and referencing the audio file storing the engine sound. The second behavior, “Behavior2”, comprises a COLLISION trigger referencing the car node and an ACTION_SET_HAPTIC action referencing the car node having the Material_Haptic_Modality array containing a single element “Temperature”.

With this scene description example, when a user sees the haptic object, the rendering of every vibrotactile signals attached to the node will be triggered. When the user collides with the object, the temperature texture attached to the node through the haptic material will be rendered.

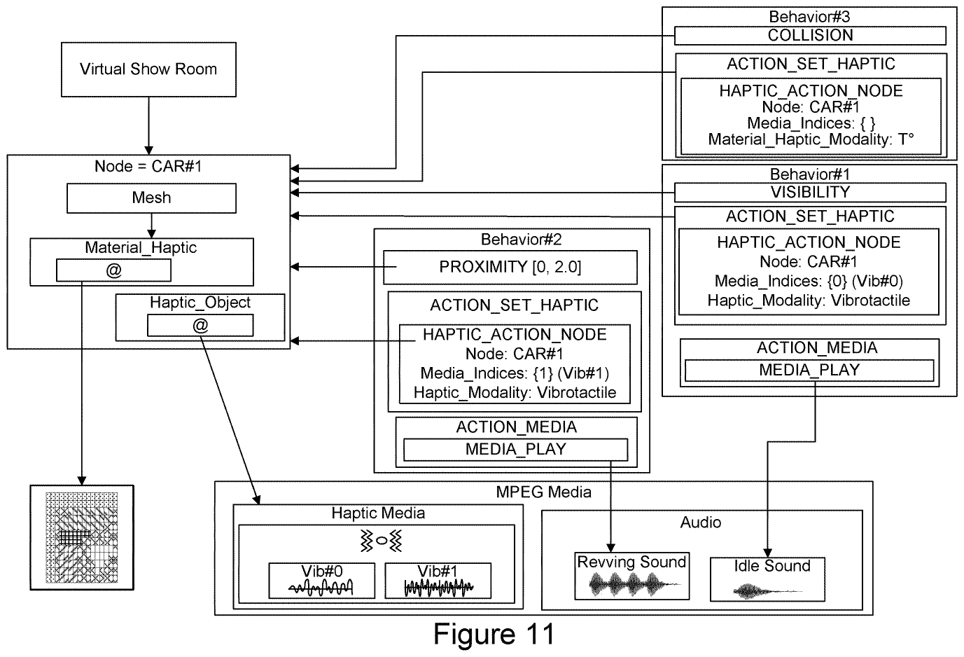

FIG. 11 shows an example of architecture of a scene description comprising an interactive haptic action according to the second embodiment. In the first example described in FIG. 10 related to the first embodiment, if two different haptic media containing the same type of haptic perception modality are attached to a node, the two files will be rendered. There is no way to control their rendering independently. For instance, a second example of interactive experience would be that the engine starts (and idles) when the user visualizes the car, thus playing a first vibration and then when the user approaches the car, to rev the engine, thus playing a second vibration. This requires triggering a first vibrotactile signal for a first behavior and triggering a second vibrotactile signal for a second behavior. Such an operation cannot be done with the first embodiment: both vibrotactile signals will be rendered when the user will see the car and when approaching in the specified distance range. However, such scenario may be implemented using the second embodiment, as described below in the second example illustrated in FIG. 11.

The corresponding interactive haptic experience can be defined using a scene description comprising a CAR #1 node, a haptic media defining a vibrotactile perception vib #0 of the engine idling, a second haptic media defining a second vibrotactile perception vib #1 of the engine revving, and a haptic material associated with a temperature texture map of the car and three haptic behaviors. The first behavior (Behavior #1) comprises a VISIBILITY trigger referencing the car node, an ACTION_MEDIA property set to MEDIA-PLAY and referencing the audio file storing the engine idling sound, an ACTION_SET_HAPTIC action with the array Haptic_action_nodes containing a single element referencing the car node, the media_indices array containing a single element set to “0” to reference vib #0. The second behavior (Behavior #2) comprises a PROXIMITY trigger referencing the car node, with a given distance range, for example set to [0, 2.0] meters, an ACTION_MEDIA property set to MEDIA-PLAY and referencing the audio file storing the engine revving sound, an ACTION_SET_HAPTIC action with the array Haptic_action_nodes containing a single element referencing the car node, the media_indices array containing a single element set to “1” to reference vib #1. The third behavior (Behavior #3) comprises a COLLISION trigger referencing the car node, an ACTION_SET_HAPTIC action with the array Haptic_action_nodes containing a single element referencing the car node with an empty media_indices array and with the Material_Haptic_Modality array containing a single element “Temperature”.

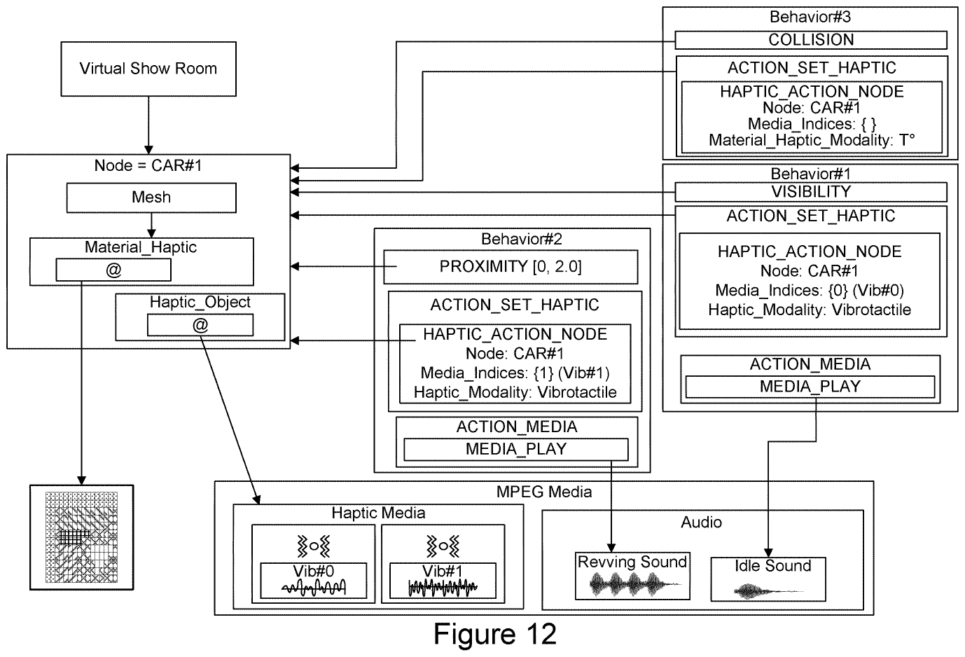

FIG. 12 shows an example of architecture of a scene description comprising an interactive haptic action according to the third embodiment. With the second example described in FIG. 11 related to the second embodiment, it is not possible to render separately two signals of the same modality if they are defined in the same media. For instance, with the same use case as in the previous example, but with the haptic data being contained in a single haptic file with two separate perceptions, the rendering of both perceptions will be triggered at the same time since the two perceptions are in the same media. The third embodiment allows to specify which perception should be rendered using the following configuration as show with the third example of FIG. 12.

The corresponding interactive haptic experience can be defined using a scene description comprising a CAR #1 node, and a haptic media defining a vibrotactile perception vib #0 of the engine idling and a second vibrotactile perception vib #1 of the engine revving, a haptic material associated with a temperature texture map of the car and three haptic behaviors. The first behavior (Behavior #1) comprises a VISIBILITY trigger referencing the car node, an ACTION_MEDIA property set to MEDIA-PLAY and referencing the audio file storing the engine idling sound, an ACTION_SET_HAPTIC action with the array Haptic_action_nodes containing a single element referencing the car node, the media_indices array containing a single element “0” to reference the haptic media file and a perception_index set to “0” to reference vib #0. The second behavior (Behavior #2) comprises a PROXIMITY trigger referencing the car node, with a given distance range, for example set to [0, 2.0] meters, an ACTION_MEDIA property set to MEDIA-PLAY and referencing the audio file storing the engine revving sound, an ACTION_SET_HAPTIC action with the array Haptic_action_nodes containing a single element referencing the car node, the media_indices array containing a single element “0” to reference the haptic media file and a perception_index set to “1” to reference vib #1. The third behavior (Behavior #3) comprises a COLLISION trigger referencing the car node, an ACTION_SET_HAPTIC action with the array Haptic_action_nodes containing a single element referencing the car node with an empty media_indices array and with the Material_Haptic_Modality array containing a single element “Temperature”.

An example of the fourth embodiment would be very similar to the third example and can be used to handle the same use case as in the second and third examples but going one step deeper in the data structure to select only specific channels of a perception that comprises multiple channels. A corresponding figure would be very similar to the FIG. 12 with an additional “channel_indices” level in the definition of the Haptic_action_node.

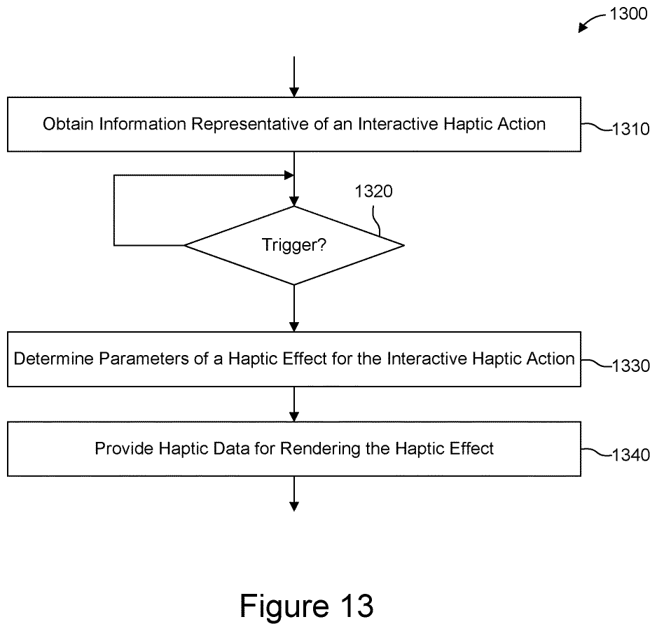

FIG. 13 shows an example of flowchart for handling interactive haptic actions according to at least one embodiment. Such a process 1300 is typically implemented in a haptic rendering device 100 and executed by a processor 101 of such a device. This process may be used for any of the embodiments described above. In step 1310, the processor obtains a description of an immersive scene (191 in FIG. 1). This may be done for example by receiving it from a server through a communication network, by reading it from an external storage device or a local memory, or by any other means. The processor analyses the scene description file in order to extract the interactive haptic action that comprises at least a trigger, for example as defined in tables 2 and 3, and a haptic effect. Examples of triggers are for example a collision between a virtual object and a representation of the user within the scene, a proximity from a virtual object, a user input, or a visibility of a virtual object. In step 1320, the processor monitors the interactions of the user with the immersive scene to detect triggers, and when the expected trigger defined by the interactive haptic action is detected, in step 1330, it determines parameters of the haptic effect, for example as defined by the element ACTION_SET_HAPTIC in tables 18 to 29. In step 1340, the corresponding haptic data is then provided for rendering of the haptic effect as defined by the interactive haptic action.

When the device implementing the process 1300 integrates the haptic actuators, the haptic signal representing the haptic effect is provided to the actuators. When the device implementing the process 1300 uses a haptic rendering device that integrates the haptic actuators, the haptic signal representing the haptic effect is provided to the haptic rendering device.

As discussed above, a device receiving and decoding the immersive scene may delegate this task to other devices, for example a dedicated haptic rendering device instead of performing the rendering itself. In this case, data is prepared for the rendering of the visual element and/or of the haptic effect and transmitted to the device performing the rendering. Such a remote rendering may be used for audio, video and haptic data and highly depends on the functionalities built-in the devices involved. In some cases, a combination of devices may be required to fully render the immersive experience. In other cases, the device comprises all elements require to perform all the tasks, including the decoding and the rendering. This is the case for example when a smartphone displays an augmented reality scene and provides vibrations when the user interacts with the scene.

Although different embodiments have been described separately, any combination of the embodiments together can be done while respecting the principles of the disclosure.

Although embodiments are related to haptic effects, the person skilled in the art will appreciate that the same principles could apply to other effects such as the sensorial effects for example and thus would comprise smell and taste. Appropriate syntax would thus determine the appropriate parameters related to these effects.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method comprising:
obtaining, from an immersive scene description, a data structure representative of an interactive haptic action, wherein the data structure is associated with a virtual object or with an immersive scene and defines a behavior element, wherein the behavior element links at least one trigger element defining a trigger condition, to at least one action element defining an action to be performed, and wherein the at least one action element is associated with a haptic effect;
responsive to an event corresponding to the trigger condition, determining parameters of the haptic effect, wherein the parameters comprise at least a type of haptic effect and a haptic signal for the haptic effect; and
providing haptic data for rendering the haptic effect based at least on the type of haptic effect and the haptic signal for the haptic effect.

2. The method of claim 1, wherein the parameters of the haptic effect further comprise an identification of a haptic signal to be provided to a haptic actuator.

3. The method of claim 1, wherein the parameters of the haptic effect further comprise a mask representing at least one part of a body on which the effect should be applied, and wherein the haptic data provided for rendering the haptic effect further comprise a selection of a haptic actuator corresponding to the at least one part of the body on which the effect should be applied.

4. The method of claim 1, wherein the parameters of the haptic effect further comprise an identification of a haptic texture determining a value of the haptic effect based on a position within the haptic texture.

5. The method of claim 1, wherein the parameters of the haptic effect further comprise a washout flag, and wherein the haptic data provided for rendering the haptic effect further comprise an indication that a selected haptic actuator should return to a neutral position.

6. The method of claim 1, wherein the parameters of the haptic effect further comprise a control flag for controlling the rendering of the haptic data, and wherein the control flag is selected from a set comprising pre-determined values at least for starting, pausing, resuming, and stopping the rendering of the haptic data.

7. The method of claim 6, wherein the parameters of the haptic effect further comprise a flag for controlling whether the rendering of the haptic data should be continuously looping.

8. A device comprising a processor configured to:
obtain, from an immersive scene description, a data structure representative of an interactive haptic action, wherein the data structure is associated with a virtual object or with an immersive scene and defines a behavior element, wherein the behavior element links at least one trigger element defining a trigger condition, to at least one action element defining an action to be performed, and wherein the at least one action element is associated with a haptic effect;
responsive to an event corresponding to the trigger condition, determine parameters of the haptic effect, wherein the parameters comprise at least a type of haptic effect and a haptic signal for the haptic effect; and
provide haptic data for rendering the haptic effect based at least on the type of haptic effect and the haptic signal for the haptic effect.

9. The device of claim 8, wherein the parameters of the haptic effect further comprise an identification of a haptic signal to be provided to a haptic actuator.

10. The device of claim 8, wherein the parameters of the haptic effect further comprise a mask representing at least one part of a body on which the effect should be applied, and wherein the haptic data provided for rendering the haptic effect further comprise a selection of a haptic actuator corresponding to the at least one part of the body on which the effect should be applied.

11. The device of claim 8, wherein the parameters of the haptic effect further comprise an identification of a haptic texture determining a value of the haptic effect based on a position within the haptic texture.

12. The device of claim 8, wherein the parameters of the haptic effect further comprise a washout flag, and wherein the haptic data provided for rendering the haptic effect further comprises an indication that a selected haptic actuator should return to a neutral position.

13. The device of claim 8, wherein the parameters of the haptic effect further comprise a control flag for controlling the rendering of the haptic data, and wherein the control flag is selected from a set comprising pre-determined values at least for starting, pausing, resuming, and stopping the rendering of the haptic data.

14. The device of claim 13, wherein the parameters of the haptic effect further comprise a flag for controlling whether the rendering of the haptic data should be continuously looping.

15. (canceled)

16. A non-transitory computer readable medium storing instructions that, when executed by a processor, cause the processor to:
obtain, from an immersive scene description, a data structure representative of an interactive haptic action, wherein the data structure is associated with a virtual object or with an immersive scene and defines a behavior element, wherein the behavior element links at least one trigger element defining a trigger condition, to at least one action element defining an action to be performed, and wherein the at least one action element is associated with a haptic effect;
responsive to an event corresponding to the trigger condition, determine parameters of the haptic effect, wherein the parameters comprise at least a type of haptic effect and a haptic signal for the haptic effect; and
provide haptic data for rendering the haptic effect based at least on the type of haptic effect and the haptic signal for the haptic effect.

17. The non-transitory computer readable medium of claim 16, wherein the parameters of the haptic effect further comprise an identification of a haptic signal to be provided to a haptic actuator.

18. The non-transitory computer readable medium of claim 16, wherein the parameters of the haptic effect further comprise a mask representing at least one part of a body on which the effect should be applied, and wherein the haptic data provided for rendering the haptic effect further comprise a selection of a haptic actuator corresponding to the at least one part of the body on which the effect should be applied.

19. The non-transitory computer readable medium of claim 16, wherein the parameters of the haptic effect further comprise an identification of a haptic texture determining a value of the haptic effect based on a position within the haptic texture.

20. The non-transitory computer readable medium of claim 16, wherein the parameters of the haptic effect further comprise a washout flag, and wherein the haptic data provided for rendering the haptic effect further comprise an indication that a selected haptic actuator should return to a neutral position.

21. The non-transitory computer readable medium of claim 16, wherein the parameters of the haptic effect further comprise at least one of:
a control flag for controlling the rendering of the haptic data, wherein the control flag is selected from a set comprising pre-determined values at least for starting, pausing, resuming, and stopping the rendering of the haptic data; and
a flag for controlling whether the rendering of the haptic data should be continuously looping.
